(19) United States
(12) Patent Application Publication
(10) Pub. No.: US 2004/0215610 A1
(43) Pub. Date: Oct. 28, 2004

(54) System and method for extracting and applying business organization information

(75) Inventors: James Dixon, Orlando, FL (US); Douglas Moran, Merritt Island, FL (US)

Correspondence Address: Schwegman, Lundberg, Woessner & Kluth, P.A., P.O. Box 2938, Minneapolis, MN, 55402, US

(73) Assignee: Lawson Software, Inc.

(21) Appl. No.: 10/784,852

(22) Filed: Feb. 23, 2004

Related U.S. Application Data
(60) Provisional application No. 60/464,607, filed on Apr. 22, 2003.

(51) Int. Cl. G06F 7/00

(52) U.S. Cl. 707/3

(57) ABSTRACT

A system and a computer-implemented method of generating a report tailored to a user within an organization having a hierarchy. Information regarding the organization hierarchy is provided. The information includes information locating the user within the organization hierarchy. Data is extracted from one or more data sources and a report is generated. Generating a report includes filtering the report as a function of the user's location in the organization hierarchy. In one approach, a hierarchy of employees within an organization is determined by extracting organization information from a plurality of data sources and linking employees as a function of the organization information to form a hierarchy of employees.

### RELATED APPLICATIONS

This application claims priority from U.S. Provisional Application No. 60/464,607, filed Apr. 21, 2003, which application is incorporated herein by references.

### FIELD OF THE INVENTION

The present invention is related to database management, and more particularly to a system and method for extracting organizational structure from disparate data sources and for using that structure to provide focused reports.

### BACKGROUND INFORMATION

Traditional methods of reporting from databases make it difficult to provide concise, user-specific information to the user. Instead, most business intelligence systems rely on users having the time and inclination to log on to the system, make a request of the server and wade through a mountain of data presented in a host of reports in order to glean those pieces of data important to them. Even if the user manages to spot something important in the mountain of data, there's no mechanism for getting related information, for accessing related applications, for finding other people to consult or collaborate with, or for taking appropriate action. As a result, the reports are ignored; important nuggets of information salient to the users' jobs are missed, buried in more junk than the users have the time or inclination to sift through.

What is needed is a system and method for extracting and applying business organization information from disparate data sources and for using that structure to provide reports focused for the user within that organization. What is also needed is a system and method for accessing additional information and applications relevant to the report and to the user. Finally, what is needed is a system and method for communicating and collaborating among users as a function the extracted business organization and the focused reports.

### SUMMARY OF THE INVENTION

According to one aspect of the present invention, a system and a computer-implemented method of determining a hierarchy of employees within an organization comprises extracting organization information from a plurality of data sources and linking employees as a function of the organization information to form a hierarchy of employees.

According to another aspect of the present invention, a system and a computer-implemented method of generating a report tailored to a user within an organization having a hierarchy comprises providing information regarding the organization hierarchy, extracting data from one or more data sources and generating a report. Providing information includes providing information locating the user within the organization hierarchy. Generating a report includes filtering the report as a function of the user's location in the organization hierarchy.

According to yet another aspect of the present invention, a system and a computer-implemented method of generating a report tailored to a user within an organization having a hierarch comprises extracting organization information from one or more data sources, determining an organization hierarchy from the extracted organization information, extracting data from one or more data sources and generating a report. Determining organization hierarchy includes locating the user within the organization hierarchy. Generating a report includes filtering the report as a function of the user's location in the organization hierarchy.

According to yet another aspect of the present invention, a report generating system is described for use in a data system having a plurality of data sources, wherein each data source includes organization information about people within an organization. The report generating system includes a processor connected to a plurality of data sources, wherein the processor extracts organization information from the plurality of data sources, determines an organization hierarchy from the extracted organization information and generates a report as a function of a user's place within the organization hierarchy. The report generating system further includes means for viewing the report generated by the processor.

According to yet another aspect of the present invention, a report generating system is described for generating reports tailored for people within an organization. The report generating system comprises a report viewing system, a plurality of data sources, wherein each data source includes organization information about people within the organization, and a processor, connected to a plurality of data sources and to the report viewing system, wherein the processor extracts organization information from the plurality of data sources, determines an organization hierarchy from the extracted organization information and generates a report as a function of a user's place within the organization hierarchy.

### BRIEF DESCRIPTION OF THE DRAWINGS

In the drawings, like numerals describe substantially similar components throughout the several views. Like numerals having different letter suffixes or primed (X′) represent different occurrences of substantially similar components.

FIG. 1 is a schematic diagram of a report generating system according to the present invention;

FIG. 2 is a method of generating an organizational hierarchy according to the present invention;

FIG. 3 is a method of generating a notification report according to the present invention;

FIG. 4 illustrates representative data for use in generating a hierarchy;

FIG. 5 illustrates representative data that can be used to generate a notification report with business organization context;

FIG. 6 illustrates a notification report which applies organization context to the data from FIG. 5;

FIG. 7 illustrates data being drawn from a plurality of data sources;

FIG. 8 illustrates a method of solving a business problem according to the present invention;

FIG. 9 illustrates filtering data from multiple data sources;

FIG. 10 illustrates a screenshot from an infoset wizard used to configure a reporting system according to the present invention;

FIG. 11 illustrates categories that can be applied to columns within a data source so that an organizational hierarchy can be derived;

FIG. 12 illustrates an example of a data source used to derive an organization hierarchy;

FIG. 13 illustrates a method of defining how a column of the data in FIG. 12 is mapped to an employee table;

FIG. 14 illustrates an example of a data source used to source data for a data set according to the present invention;

FIG. 15 illustrates a method of defining a data set for each line of FIG. 14;

FIG. 16 illustrates a method of filtering a data set;

FIG. 17 illustrates a notification report according to the present invention;

FIG. 18 illustrates a wizard for defining additional filtering;

FIG. 19 illustrates a notification report formed from the data set filtered as shown in FIG. 18;

FIG. 20 illustrates a method of selecting operations to be performed on the filtered data shown in FIG. 18;

FIG. 21 illustrates a notification report formed from the data set filtered as shown in FIG. 20;

FIG. 22 illustrates a method of adding collaboration links to data displayed with organization context;

FIG. 23 illustrates a method of configuring instant messaging;

FIGS. 24a and 24b illustrate different ways to present a notification report with collaboration links 200

FIG. 25 illustrates an organization hierarchy showing members of an organization and their place within the organization;

FIGS. 26 and 27 illustrate alternate methods of displaying data from notification reports;

FIG. 28 illustrates a method of configuring notification report delivery;

FIG. 29 illustrates representative types of notification reports which can be sent to and types of people who receive them;

FIGS. 30-32 illustrate examples of user-defined notification reports;

FIG. 33 illustrates a method for adding custom links to data displayed in a notification report; and

FIG. 34 illustrates a notification report based on the configuration chosen in FIG. 33.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

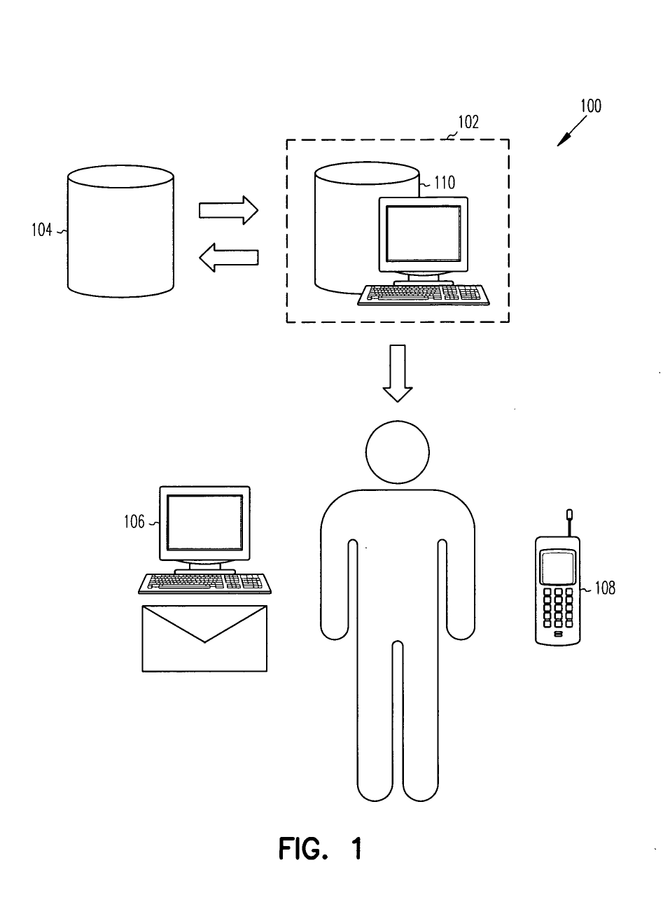

A system 100 for extracting and applying business organization information from disparate data sources and for using that structure to provide notification reports focused for users within that organization is shown in FIG. 1. System 100 includes a processor 102 connected to one or more data sources 104. Each data source 104 includes organization information about people within an organization. Processor 102 extracts organization information from the plurality of data sources, determines an organization hierarchy from the extracted organization information and generates a notification report as a function of a user's place within the organization hierarchy. The notification report is displayed, for example, on the user's workstation 106 (or on another viewing device 108, e.g., telephone). In one embodiment, processor 102 includes memory reading device 110 capable of reading data from a nonvolatile computer-readable medium. Program code for execution on processor 102 could be stored, for example, on a computer-readable medium stored in memory reading device 110.

In one embodiment, processor 102 reads information about an organizational hierarchy from one data source 104 and applies it to data from another data source 104, adding a significant amount of information in the process. This new information can be used for decision-making, communication and collaboration.

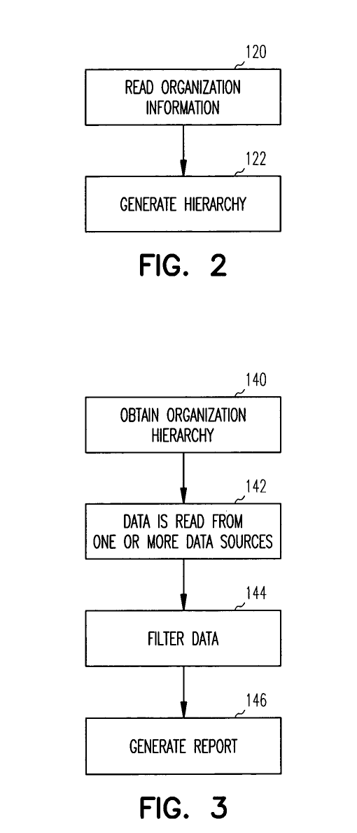

A method of generating an organization hierarchy from one or more data sources 104 is shown in FIG. 2. At 120, processor 102 reads organization information from one or more data sources 104 (including, for example, LDAP, Lotus Notes, XML and other files, Relational Databases, and applications that can return the data over the Internet). The information includes, at a minimum, an employee identifier for each person in the organization and a supervisor identifier for each person in the organization with a supervisor. Processor 102 then generates, at 122, an organization chart detailing the organization hierarchy. In one embodiment, the organization chart is presented graphically. A graphical presentation is not, however, necessary for the invention to work.

In one embodiment, the hierarchy is stored by processor 102 and refreshed periodically (e.g. daily). In one such embodiment, the hierarchy is based on user IDs. In an alternate approach, the hierarchy is based on names instead of user IDs.

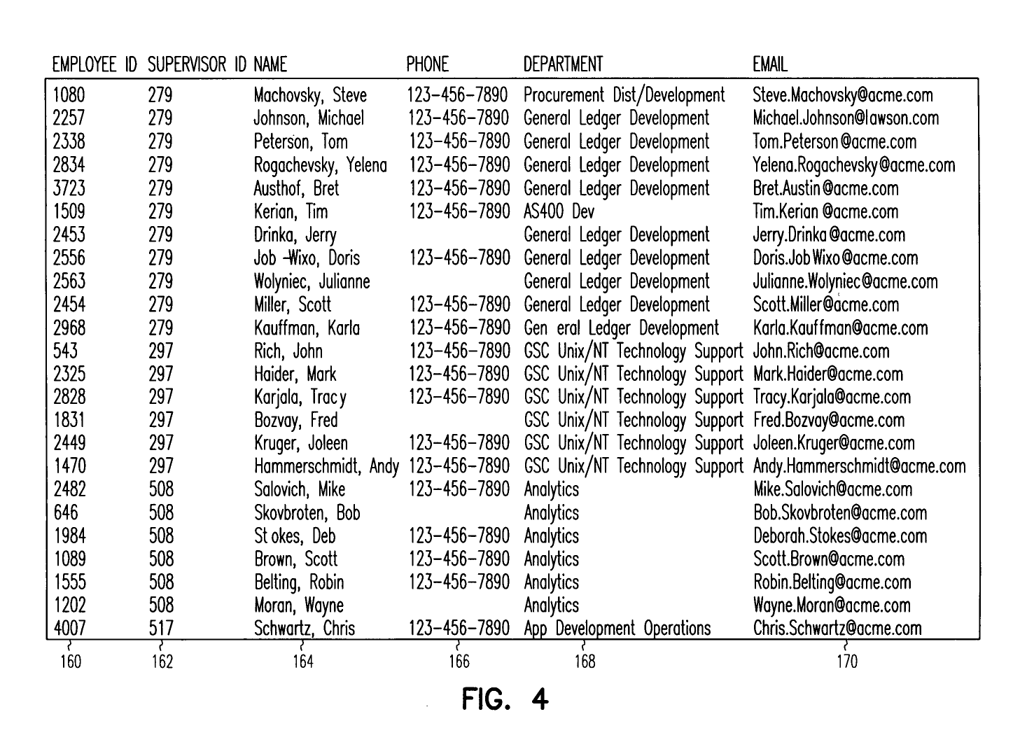

A method of generating a notification report tailored to one or more users within an organization is shown in FIG. 3. In the flowchart of FIG. 3, at 140, processor 102 obtains information detailing an organization's hierarchy. In one embodiment, the hierarchy is generated as discussed above in the discussion of FIG. 2. Processor 102 moves to 142 and reads data from one or more data sources 104. The data is filtered at 144 and processor 102 generates a report known as a notification report 146 with the filtered data. The notification report 146 can be viewed, stored or delivered to a device 106 or 108.

In one embodiment, processor 102 reads data from the same or (typically) different data sources 104. Some of this data includes user ids. Processor 102 filters this data using thresholds and prepares a notification report.

An example of data for generating a hierarchy is shown in FIG. 4. In the example shown in FIG. 4, Employee ID 160 and Supervisor ID 162 are used to construct the organizational hierarchy. This is an example of data from an application that contains user IDs.

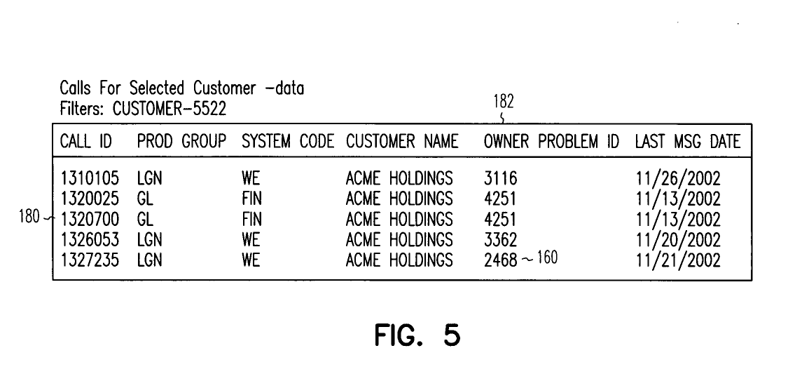

An example of data to be used to generate a notification report with business organization context is shown in FIG. 5. This data provides information about support calls that a customer has logged. The data identifies each support call with a support call identifier 180 and lists the owner 182 of each support call by user ID 160.

It can be clearly seen that the application that provided this data has no understanding of the structure of the organization receiving the support calls. Someone receiving the notification report shown in FIG. 5 would know that the Owner 182 of each support call is an employee. The employee IDs 160 in the data are, however, dry; they add very little information. In order to understand this data the receiver of the notification report will have to look up each employee ID in a different application to find out who they are and where they fit in the organization. This step will need to be performed before these people can be contacted.

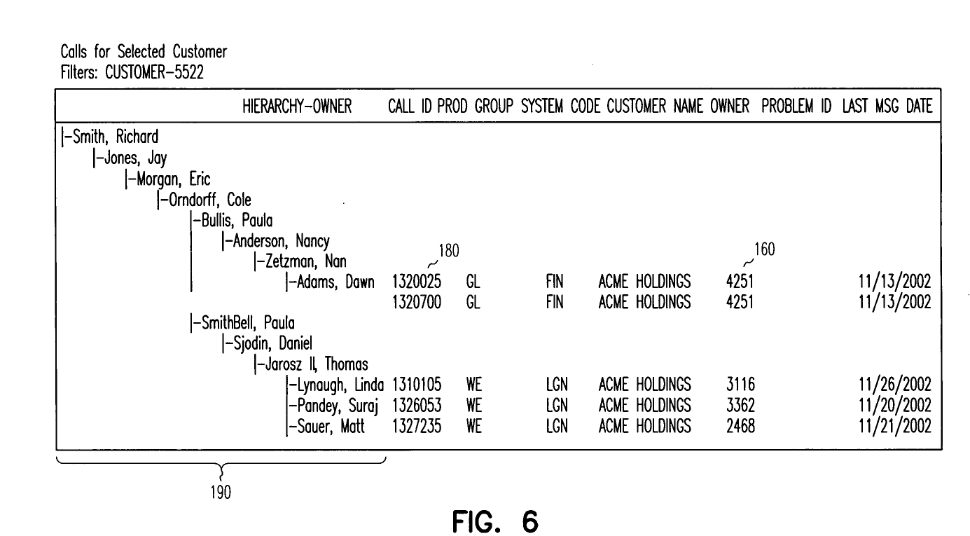

The example shown in FIG. 6 applies organization context to the data from FIG. 5. In the example shown in FIG. 6, a hierarchy 190 provides organizational context to the data of FIG. 5. One can now see the names of the people who received the support calls, their organizations and their supervisors. The hierarchy, therefore, improves the data in a number of important ways:

1) Employee names are added. The viewer now has a name, and can go immediately to email or a phone directory.

2) Organizational grouping is evident. It is immediately apparent that the owners of the five support calls fall into only two parts of the organization. In a large organization, organizational grouping can give early warning of problem clusters, or of the need for additional training or resources.

3) Contact reduction. It is easy to see that by contacting Thomas Jaroz about this topic I can reduce the amount of communication time needed to discuss this topic.

4) Contact choice. You may know that Thomas Jaroz is on vacation. In the example shown, we have turned four employee IDs into fourteen employees names that can be contacted. Communication choices can be made on the urgency and priority of the problem, not on the ability of the viewer to navigate the organization chart.

5) Closest single common parent. It also evident where in the organization a single common owner can be found, in this case Cole Orndorff. Without the calls owned by Dawn Adams the closest single common parent would be Thomas Jaroz.

Someone reading this notification report could now contact each of the employees for an update on the problems they were solving, or go to their supervisor for a slightly more abstracted view. The data is the same, but with the hierarchy added it is much easier to understand and act upon. In addition, as you look at the notification report day to day, the person most closely related to the issue to be addressed may move up the organization. On one day, it may be a line manager in Dallas. On another, it might be the head of customer service.

The hierarchy adds a lot of contextual and important information to data which is without meaningful context. That hierarchy can be applied to any data source. There simply has to be one or more data sources from which you can extract organization structure and some way to tie the organization structure to the data in the data source being analyzed.

It should be clear that the data source being analyzed does not have to be aware that a field within it is an employee. The application which tracks calls in FIG. 5 simply assigns an owner to each call. It doesn't care if the owner is an employee. Similarly, many database applications have custom fields. For instance, a customer could say the second custom field is my “feed-back manager,” that the role of feedback manager is specific in our company and that it is something we consider to be a strategic advantage in the way we handle our customers so it is specific to our customer.

When the data is set up to be analyzed, processor 102 doesn't know that the second custom field is actually an employee of the customer. As part of the setup, it is told that second custom field is a person within the organization. Processor 102 can then tie the data from the second custom field to the organization hierarchy to shown hierarchical data. No existing programs have to be modified. Processor 102 is the only one that has to know that the data is actually an employee and that we can apply a hierarchy to it. We can, therefore, apply a hierarchy to any data source, it doesn't need to be related in anyway to where the hierarchy came from.

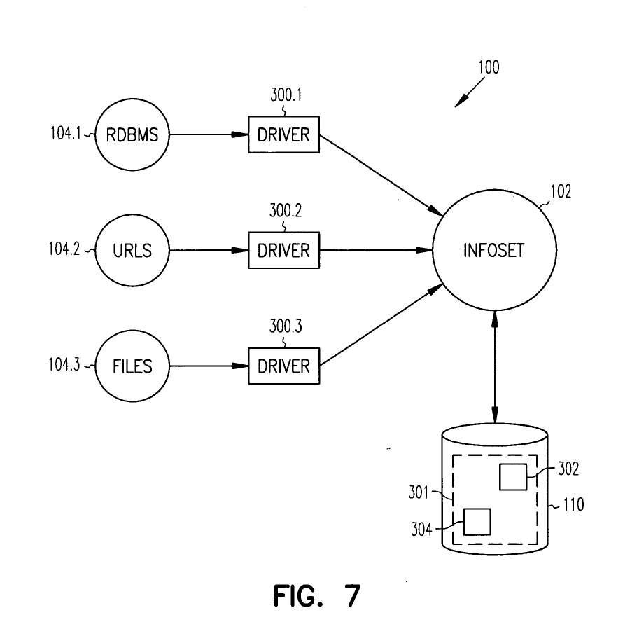

Processor 102 can pull the hierarchy from a number of different places. An illustration showing data being drawn from a plurality of data sources 104 is shown in FIG. 7. In the system shown in FIG. 7, a driver 300 is written for each data source 104 to extract data relevant to the notification report being generated. In the example shown, driver 300.1 extracts data from a relational database 104.1, driver 300.2 extracts data from, for example, an XML document 104.2, and driver 300.3 extracts data from a file 104.3.

In one embodiment, system 100 includes a number of predefined drivers 300. If employee information is stored within an Oracle database, we would create and store a predefined driver which can be pointed to specific fields within an Oracle database. Or a driver might be written to extract data from a particular application running on the Oracle database. The data could then be used to generate an employee table 302 as part of infoset 301. Employee table 302 is stored in memory device 110. In one embodiment, system 100 is configured such that new drivers can be added to pre-defined drivers 300 without rebuilding system 100.

Processor 102 would then connect to another application. For instance, it might submit a URL and receive an XML or other such document. Processor 102 creates a data set 304, categorized again by the same categorization used in generating employee table 302 (e.g., by employee ID). Now processor 102 has something in common between employee table 302 and data set 304.

Data set 304 may have more than one column that can be associated with a member of the organization. For instance, a data set 304 drawn from customer information may include an account manager, a sales representative and a customer service representative. Processor 102 would categorize each of these three columns the same way. In one approach, a user configures processor 102 to select a particular role (e.g., sales representative) for generating the hierarchy. In another approach, a notification report includes a separate hierarchy for each role. In yet another approach, the role each member plays within the hierarchy is indicated by color coding the name or user ID of the member, or through the use of symbols or other such indicators.

In one embodiment, the location of the column to be used as the employee ID is stored as metadata. In addition, metadata stores queries into each of the data sources 104, locations and format of data to be used within the data sources 104 and any parameters controlling access to data sources 104.

Metadata is also used to store actions to be performed on data extracted from data sources 104. For instance, calculations may be performed on certain pieces of data (e.g., calculating the average amount of time to respond to an event), or one set of data may be mapped into another set of data (e.g., a user ID in one data source 104 may be mapped using a user ID to employee ID mapping to create an intermediate data source 104).

Once you have infoset 301, you can solve particular business problems. For instance, you can generate a notification report highlighting late paying customers sorted by sales representative. Or you can identify customers dropping services by account representative. Or you can highlight customers meeting predefined criteria by account representative.

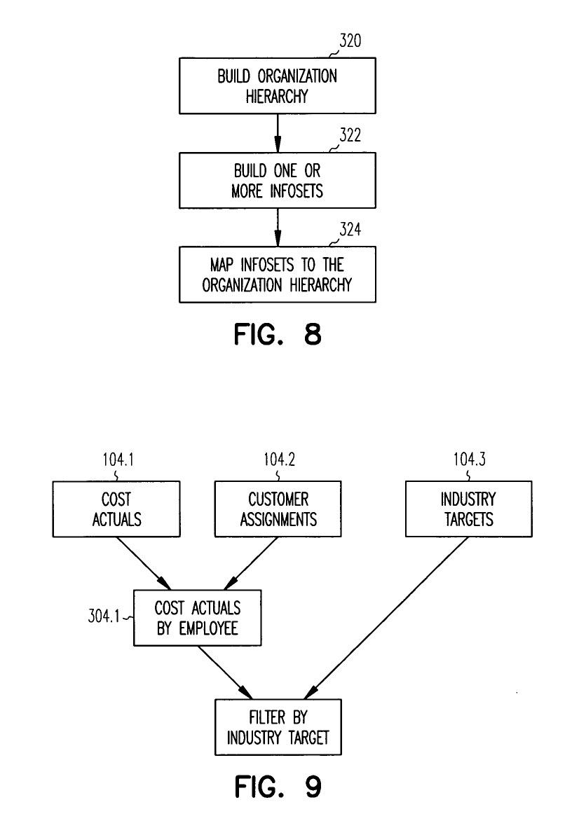

A method of solving a business problem is shown in the flowchart of FIG. 8. At 320, processor 102 generates an organization hierarchy. At 322, processor 102 builds one or more data sets 304. At 324, data from the one or more data sets 304 is mapped to the organization hierarchy. In one embodiment, building the one or more data sets 304 includes filtering the data with thresholds stored as metadata.

An example of this is shown in FIG. 9. In the example shown in FIG. 9, cost actuals are stored in one data source 104.1. A database of the customers assigned to each employee is stored in data source 104.2. A table of expected costs by industry is stored as a file in data source 104.3.

Processor 102 reads the cost actuals data from data source 104.1 and the customer assignment information from data source 104.2 and generates a cost actuals per customer by employee in data set 304. In addition, data set 304 includes a mapping of customer to industry. (Or the mapping of customer to industry may be in another file 304 altogether.) The data in data set 304 is then filtered using expected costs per industry taken from with table of expected costs by industry in data source 104.3.

The resulting filtered data is mapped to the organization hierarchy and displayed.

Other business problems can be solved as well. You might want to focus on customers who are late paying their bills. Processor 102 would go out to an application or a database 104 and create a data set 304 which includes customer invoice history. We may have another data source 104 which maps each customer to an employee. In addition, we may have a further mapping of customers to sales representatives, to account managers, or to direct sales agents. That information may or may not be part of the data in the first data source 104.

At this point processor 102 creates the notification report. The notification report selects information from the one or more data sets 304 we created to solve the business problem. In this case, processor 102 creates a notification report containing the names of late paying customers. In other situations, the notification report could be based on anything you can get to from any of the data sources 104. For instance, it could be utilization rates of employees, or people on training courses that are being rescheduled. It could be people who own a certain problem within the organization, it could be someone who has requested a purchase order, or it could be the uses for certain resources.

Processor 102 can track changing situations. For instance, you might have a list of items returned to warehouses due to shipping errors. The total number of items is calculated for each warehouse and a list of warehouse with an unacceptable number of returns is created. Each month processor 102 runs the list and compares it to the list generated in the previous month to generate a list of warehouses that used to be acceptable, but are no longer. The application tracking the returns may not be able to do this calculation. In addition, the application may not be able to tie the warehouses to particular location managers. The creation of notification reports 146 by processor 102 from data sets 304 is therefore very valuable

Hierarchy is used to provide collaboration opportunities and context. It can also be used for grouping. For instance, a notification report lets you know that there may be a problem with one or more people within my organization. The problem may be a management problem, or a personnel problem. For instance, a notification report may show that radiology nurses are underutilized. That is, that across the entire organization, it is always the radiology nurses who are underutilized. Such a problem may only become apparent when you have categorization for things like roles. That is, the application tracking a nurse's time card may not know anything about the role of that person. All it knows is that they clock in at this time and clock out at that time. We get a better understanding of the problem by applying the data to the organization hierarchy.

Configuration of the Reporting System

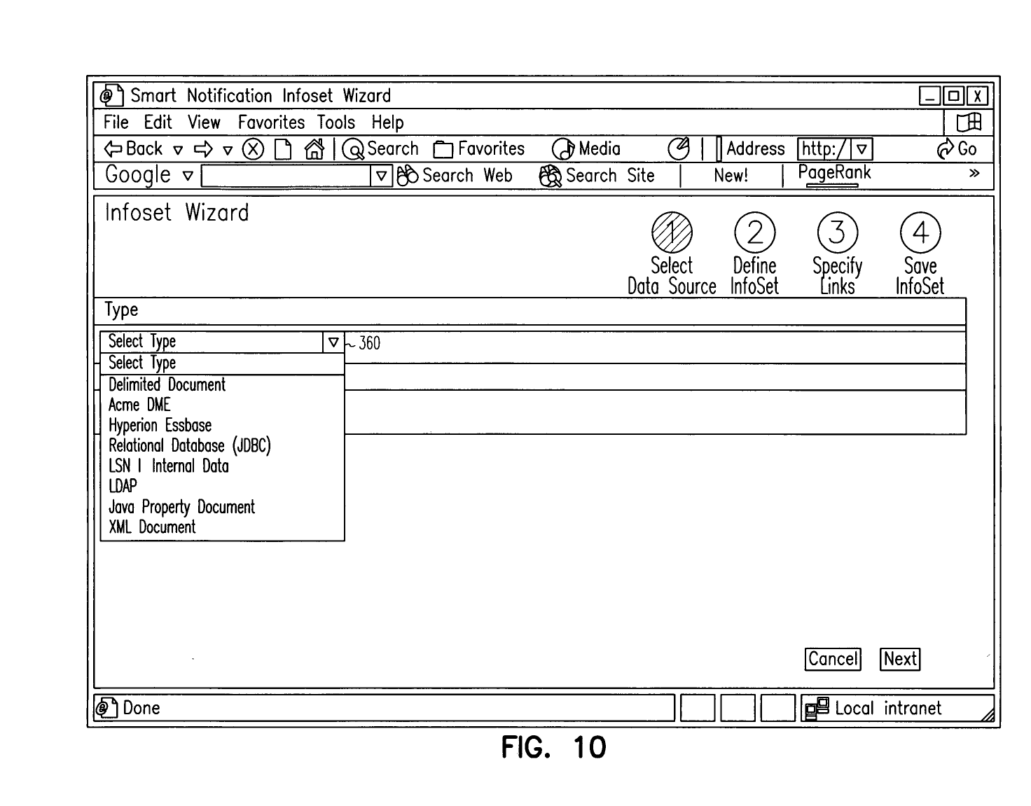

A method for configuring processor 102 is discussed next. FIG. 10 illustrates a screenshot from an infoset wizard used to configure reporting system 100. As shown in the embodiment shown in FIG. 10, the first step is to define an employee table 302. As can be seen in FIG. 10, data can be drawn from any of the listed data types 360. These include delimited documents, Lawson DME, Hyperion Essbase, a JDBC relational database, LSN internal data, LDAP, a Java Property document and an XML document. Other data types can be added by defining the appropriate drivers 300.

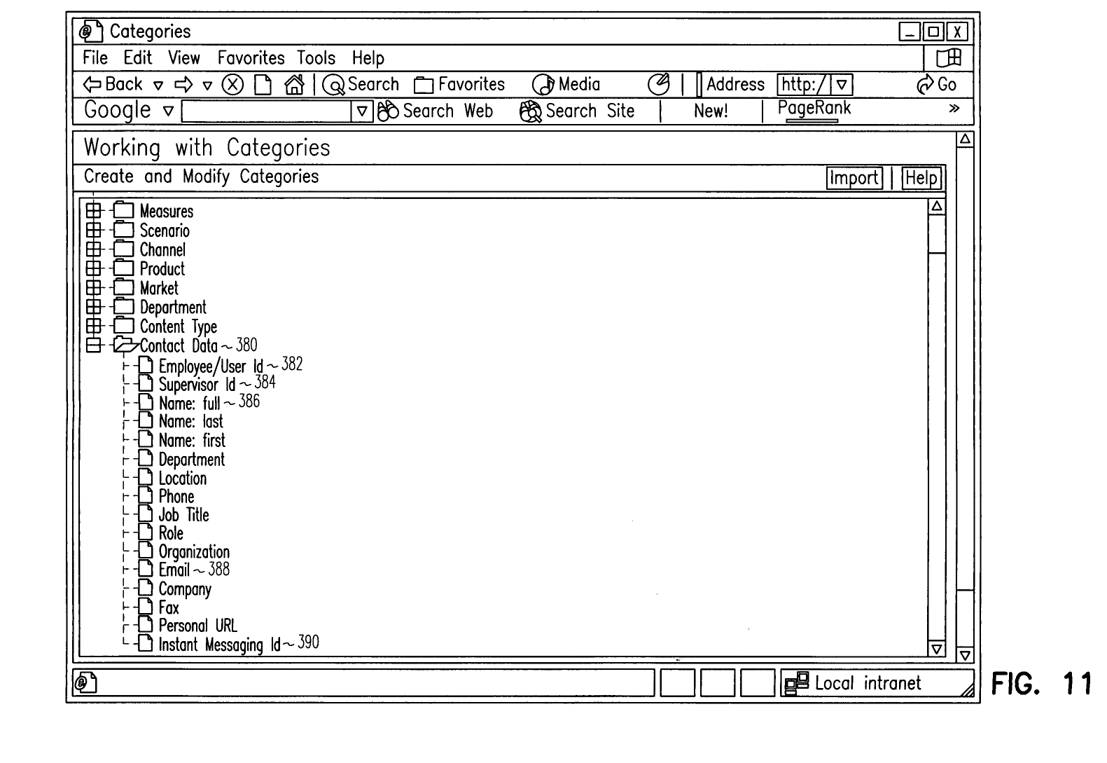

FIG. 11 illustrates categories that can be applied to columns within a data source 104 so that an organizational hierarchy can be derived. As can be seen in FIG. 11, contact data section 380 includes a number of different categories used to categorize data from a data source 104. The original data source 104 do not need to know about the categories available to processor 102. This information is part of the stored metadata. In the example shown, the most important categories are Employee/User ID 382 and Supervisor ID 384 (in order to build the hierarchy). Other important categories include Name 386, Email 388 and Instant Messaging ID 390.

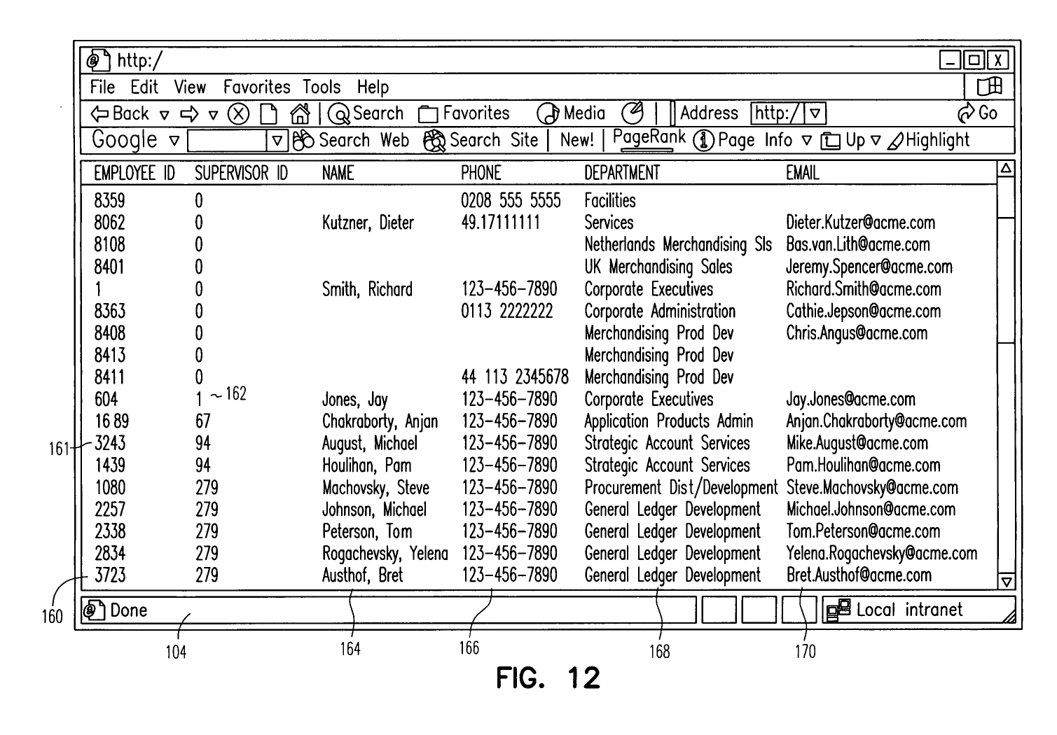

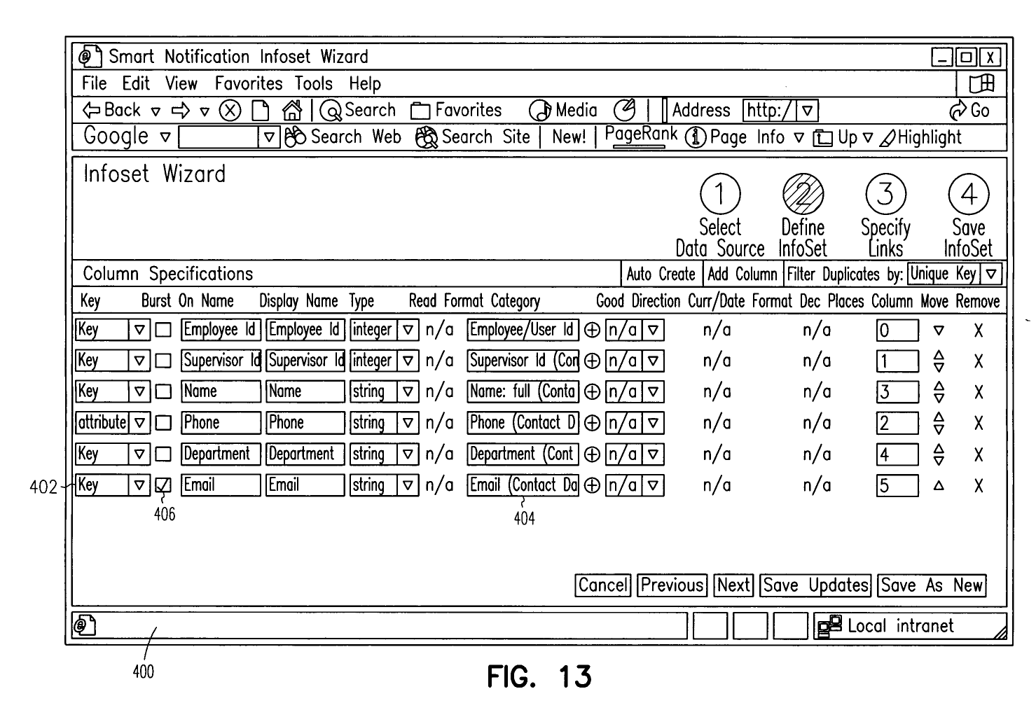

An example of a data source 104 used to derive an organization hierarchy is shown in FIG. 12. In the example shown in FIG. 12, each line 161 includes an entry for a particular employee. Each entry includes their name 166, their employee ID 160, their supervisor ID 162, their telephone number 166, their department 168 and their email address.170. FIG. 13 shows how the data from data source 104 in FIG. 12 is mapped to an employee table 302.

As can be seen in FIG. 13, each line 402 in screen shot 400 defines how a column of the data in FIG. 12 is mapped to employee table 302. This includes a category 404 from the contact data category list 380. For instance, the first column is an integer mapped to the supervisor ID category (see categorization column 404). This information is stored by processor 102 as metadata. Where a column in the dataset 304 includes a delivery destination (such as an email address, fax number, or instant messaging id) the metadata for the employee table 302 includes an indication 406.

In one embodiment, a key/attribute column is used to define how each column can be used in the creation of a notification report. Data denoted as key is data that can be used in defining the uniqueness of a row, or in linking between datasets, or as items to be aggregated (e.g. employee id, customer id, location code). Data denoted as a measure is numeric or date data that can be used in calculations or compared to thresholds (e.g. salary, invoice amount, due date). Finally, data denoted as an attribute is data that is useful information but that is not aggregated, compared or used to for links (e.g. phone number).

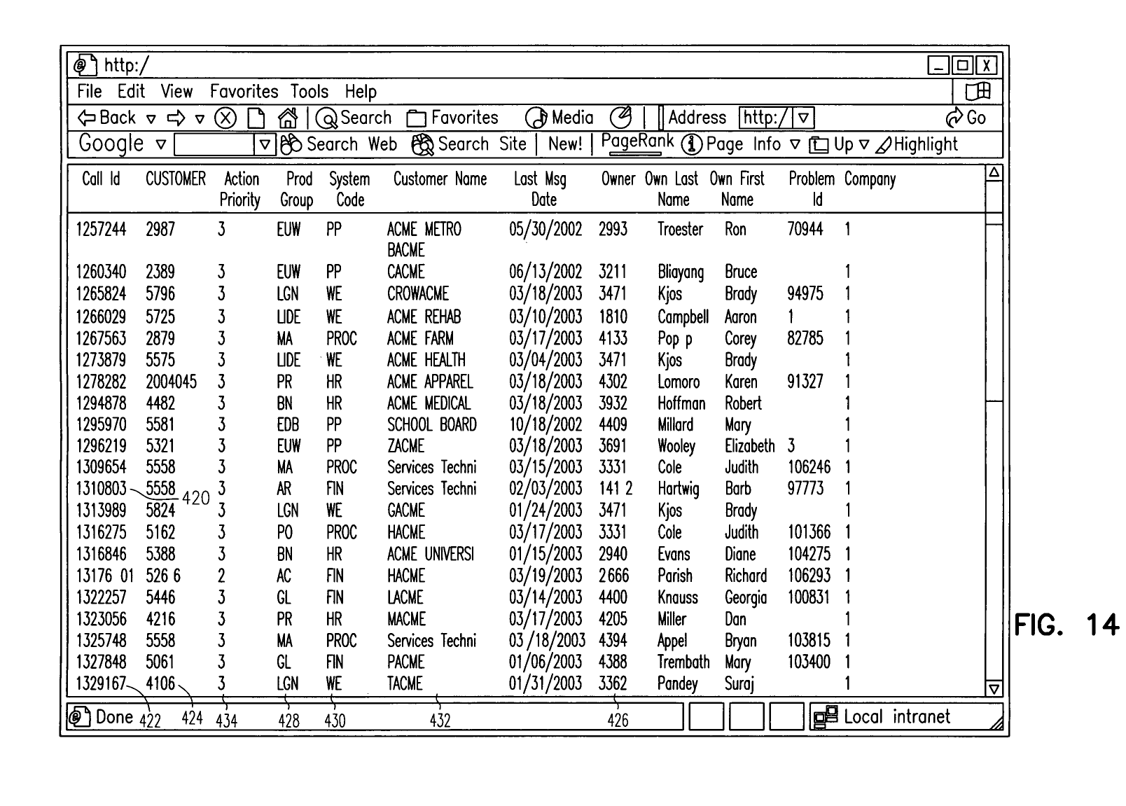

An example of a data source 104 used to source data for data set 304 is shown in FIG. 14. In the example shown in FIG. 14, each line 420 includes an entry for a particular problem call. Each entry includes a call ID 422, a customer ID 424, and an owner ID 426.

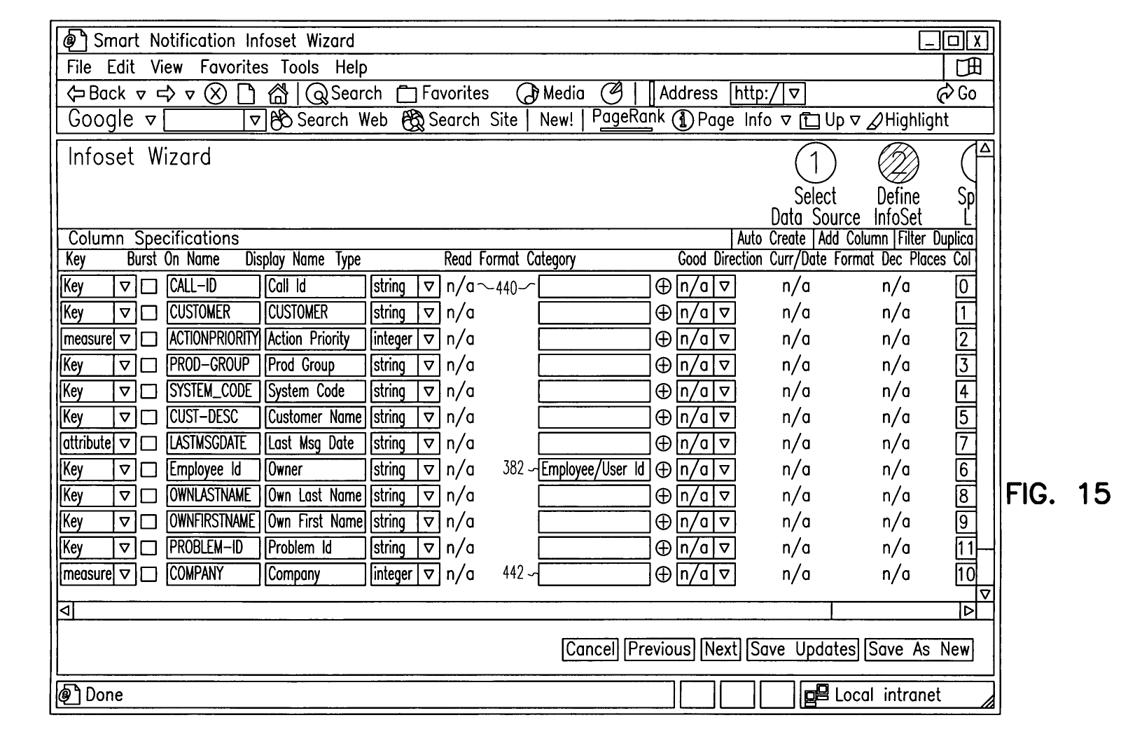

As can be seen in FIG. 15, data set 304 is defined for each line 420 of FIG. 14. Each line 440 in FIG. 15 defines a column in data set 304. Column 442 defines categories (such as contact data 380) used to tie data set 304 to employee table 302. As can be seen in FIG. 15, the owner column 426 in FIG. 14 has been tied to Employee/User ID category 382.

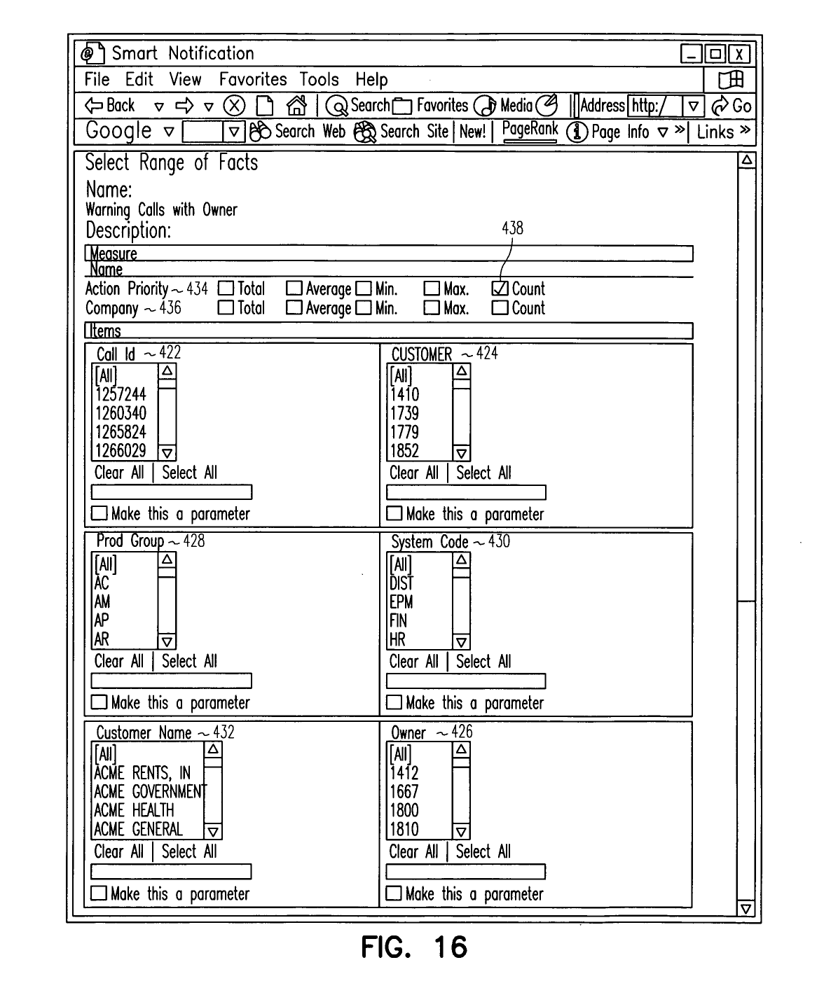

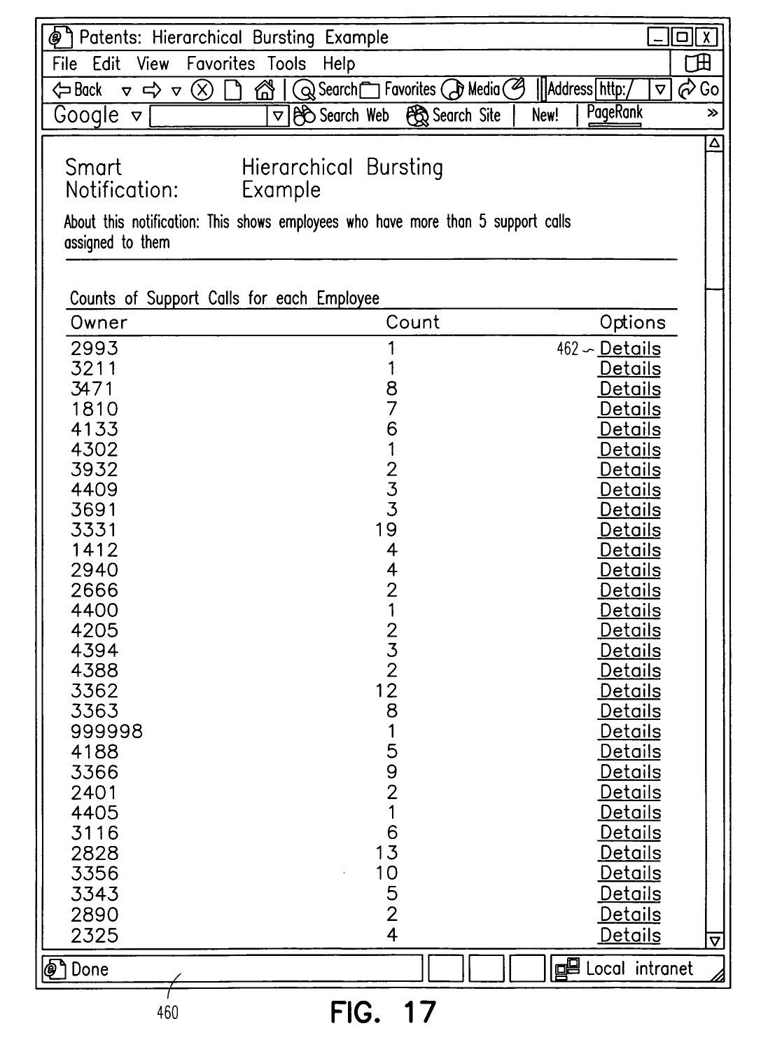

As noted in FIG. 3, data set 304 may be filtered. An example of this is shown in FIG. 16. In the example shown in FIG. 16, data set 304 can be filtered based on call ID 422, customer ID 424, product group 428, system code 430, customer name 432 and owner 426. In addition, an aggregation can be performed by processor 102. For instance, the number of calls assigned to each employee can be determined by checking box 438 in FIG. 16. The aggregation is not a capability of the application or data source 104 where the data is obtained. It is performed by processor 102 as part of the building of a notification report 460 from an infoset 301.

The resulting notification report 460 is shown in FIG. 17. Here, each owner ID 426 is associated with one or more support calls. Details about the support calls can be obtained by clicking details 462. In the embodiment shown, underlining the entry (as in details 462) indicates you can click that item for further details.

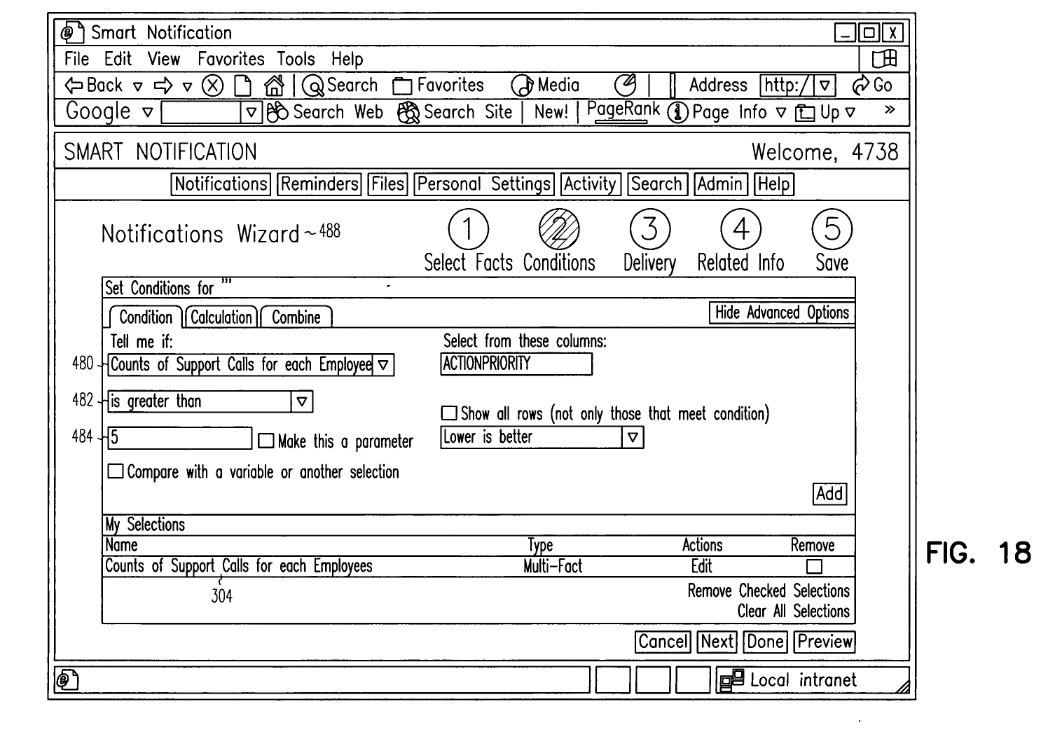

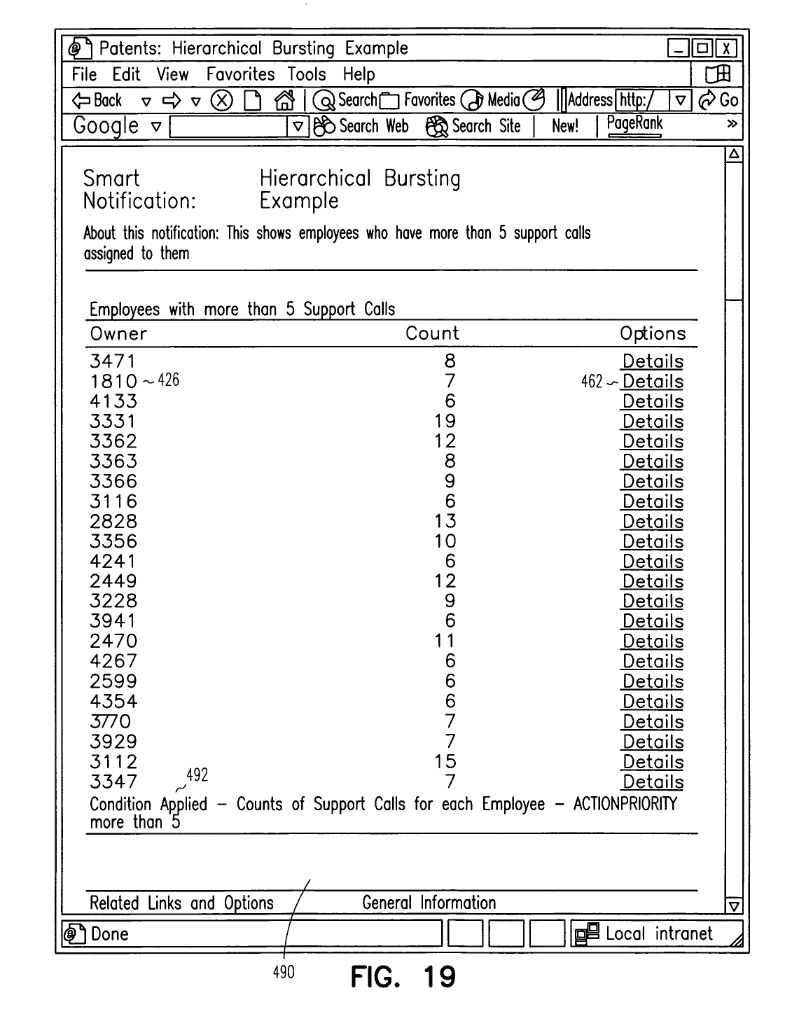

A wizard 488 for defining additional filtering is shown in FIG. 18. In the example shown in FIG. 18, users select parameters 480 and threshold conditions 482 and 484 that must be met for the entry to be in a notification report 460. A notification report 490 formed from the data set 304 filtered as shown in FIG. 18 is shown in FIG. 19. In one embodiment, notification report 490 includes a comment line 492 listing the conditions met by the data in notification report 490.

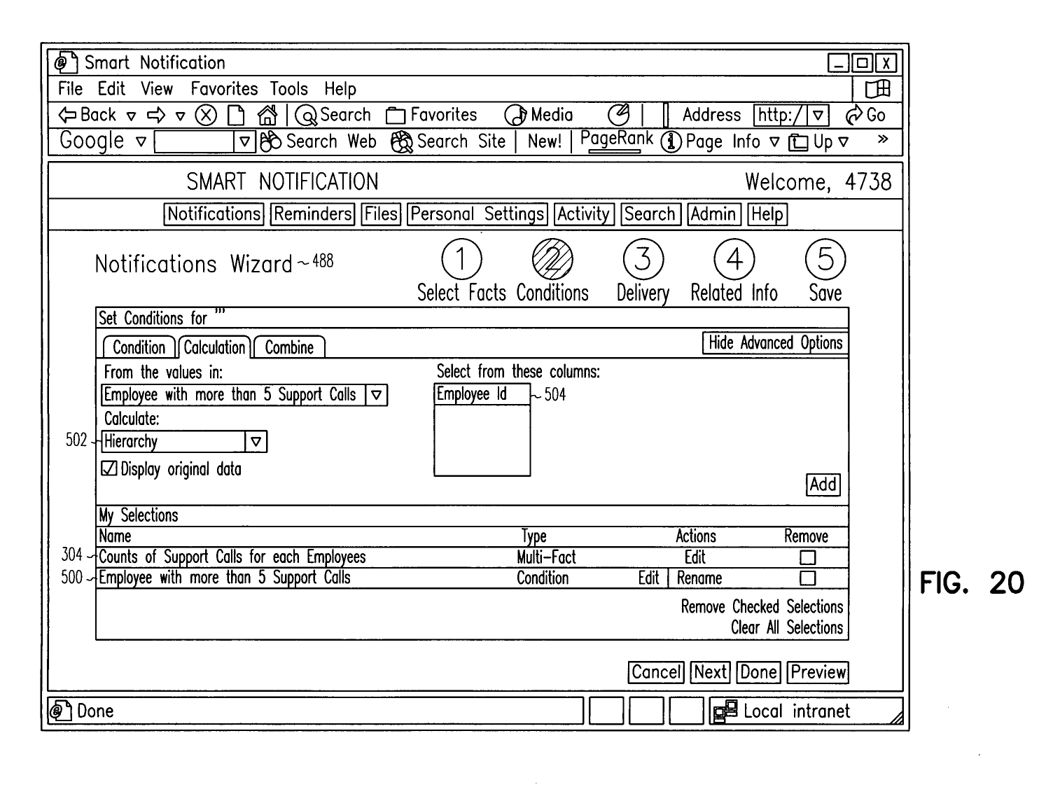

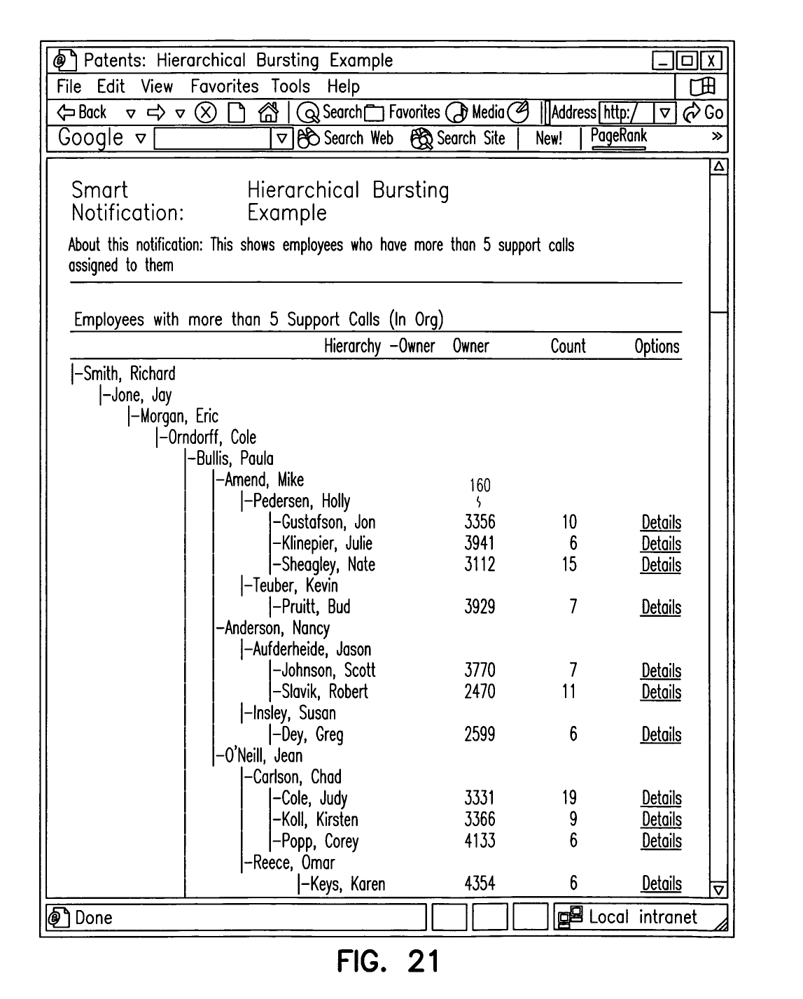

Wizard 488 also lets the user select operations to be performed on the filtered data. In the example shown in FIG. 20, the data set 304 “Counts of Support Calls for each Employee” has been filtered by the conditions 500 stored for “Employees with more than 5 Support Calls”. The user now selects a notification report format based on drop down menu 502 and column 504. The result is shown in FIG. 21. In another embodiment, the intermediary information used to create the hierarchy is stored within a notification report.

In one embodiment, each notification report is stored in a table as a collection of attributes that describe the name of the notification report and who owns it. And then for each piece of data, it defines the data set 304 to go to and the subset of each data set to include. The table also defines any filters, thresholds and calculations that are applied to generate new tables. The data may be filtered before being stored in a data set 304, or may be filtered dynamically coming out of one or more data sets 304.

In one embodiment, system 100 is capable of comparing a new list to a previous list. For instance, one might want to look at the list of customers who are no longer paying for gold-level support. We have to keep a list of who were the customers last time and a list who were the customers this time. The lists are compared and an exception list generated. The current list is then stored as the previous list.

Adding Collaboration Links to the Hierarchical Data

Once a hierarchical notification report is generated, it can be distributed by email or through instant messaging. Instant messaging can be used not only to deliver the notification report; it can also be used to solve a business problem, by facilitating collaboration directly from the report.

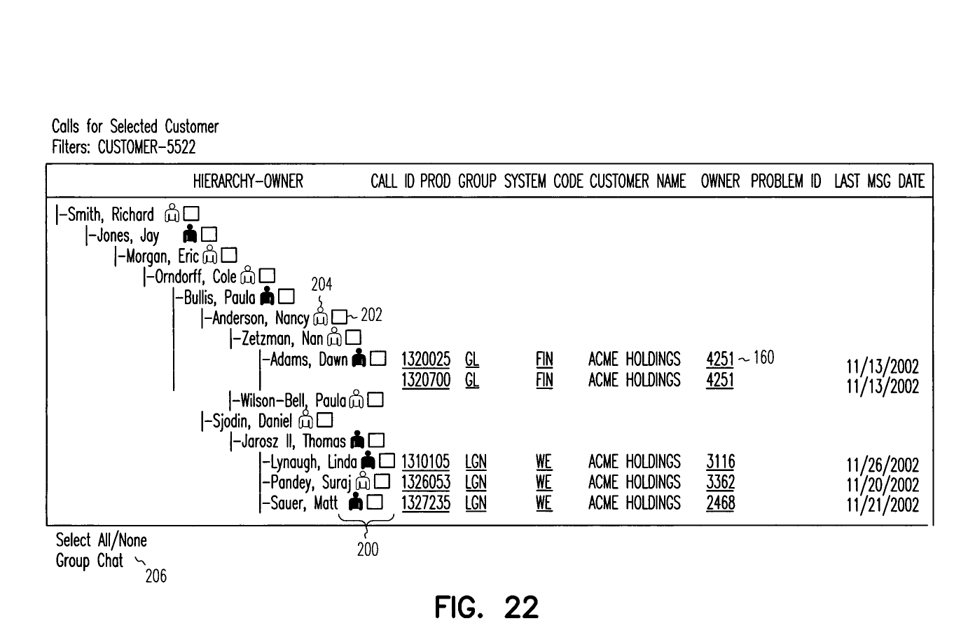

In one embodiment, processor 102 includes the capability to add collaboration links 200 to data displayed with organization context. One such embodiment is shown in FIG. 22. In the approach shown in FIG. 22, each collaboration link 200 includes an icon 202 and a check box 204. These links can be used to enable an Instant Messaging (IM) service to show the viewer the people who are online and available to collaborate.

As noted above, the data can be read from a number of sources 104. The data sources do not need to know about Instant Messaging. Instead, processor 102 stores meta-information regarding as part of infoset 301 in, for example, media reading device 110.

In the example shown in FIG. 22, each notification report includes an instant messaging capability. In the embodiment shown in FIG. 22, an icon 204 and a check box 202 have been added to the data displayed in FIG. 6. Icon 204 indicates if that person is online. Clicking on an icon 204 initiates an IM session with the person associated with the icon 204. Check box 202 is used to invite one or more people into a chat regarding the data in the notification report.

In one embodiment, each employee ID 160 includes a link to the person's email address. Clicking on the user ID opens a new message to that person.

The example shown in FIG. 22 shows how system 100 can provide a collaboration wrap around any application. Once again, this again is driven off the fact that we categorized something within the application as an employee ID. The application may know nothing about instant messaging. It may not even know it is storing data that is or can be mapped to an employee identifier. Instead, processor 102 applies the instant messaging icons to data when it is displayed. That is basically a generic capability to be able to apply instant messaging to data from any source.

In the example shown in FIG. 22, once processor 102 applies a hierarchy, it can apply the instant messaging icons 204 to the hierarchy. A unique thing here is that when it is applied to the hierarchy, more people who may be able to solve the business problem are displayed. If I have ten rows of data, I may end up with 20 different people in a hierarchy. The person I may want to contact may not be on line, but his supervisor might be. I can very quickly find out what the issue is without having to resort to going somewhere else in the organization chart or picking up the phone or sending an email. You have the power of instant messaging.

In the embodiment shown in FIG. 22, the check boxes 202 next to each contact can be used. As noted above, system 100 provides many more points of contact and an icon 203 which can be used as an on-line indication.

In the embodiment shown in FIG. 22, if the user sees a number of people on line, he can invite them into a group chat. He simply clicks on the check box 202 next to each person he wants to include and then clicks on group chat 206. The software then dynamically creates a chat room and invites each of these people checked to join the chat. So system 100 can dynamically create a unique chat room based on a combination of the exception data generated for the notification report, the hierarchy applied and the selection of the users based on who was on line.

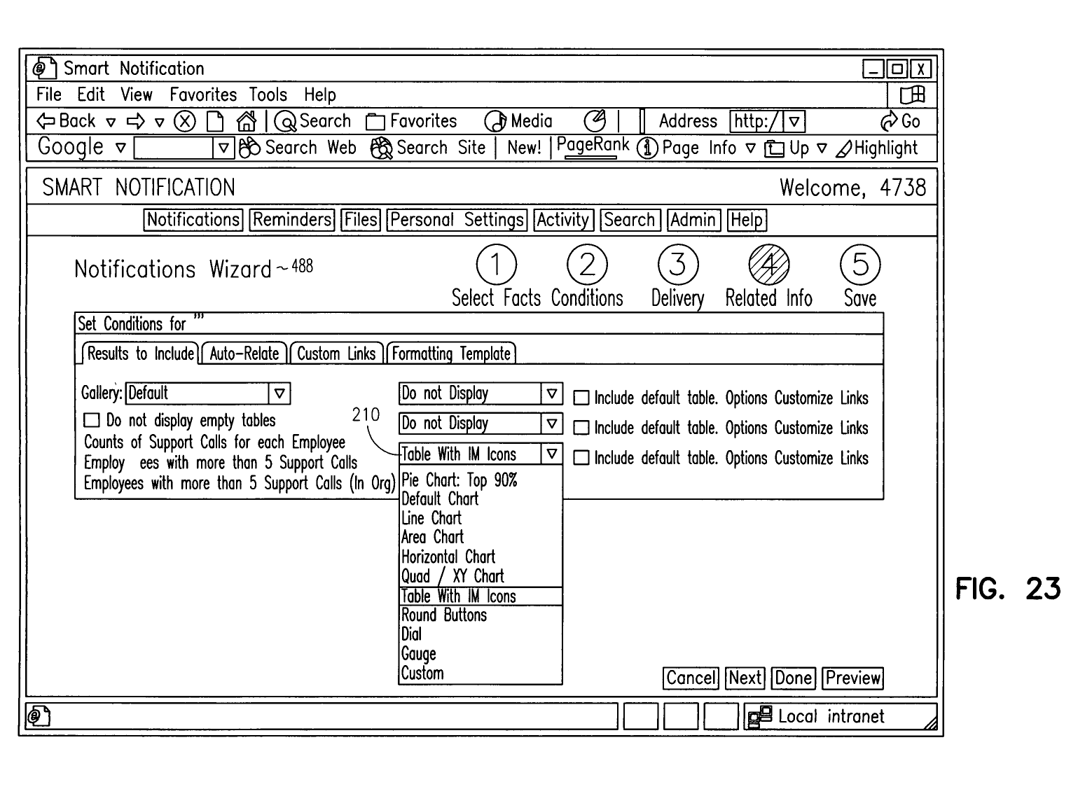

FIG. 23 shows a method of configuring instant messaging. The wizard 488 shown in FIG. 23 allows the user to select what will be displayed as part of the notification report. In the embodiment shown, the user can select the notification report to be displayed and the format using drop down menu 210. Each notification report can include custom links as discussed below.

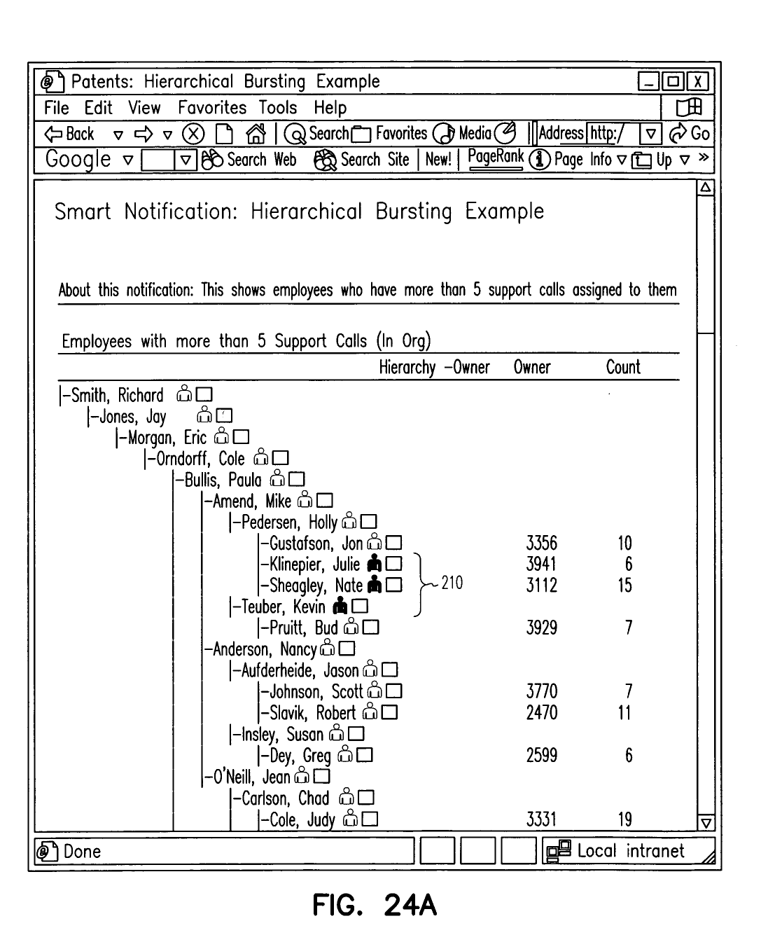

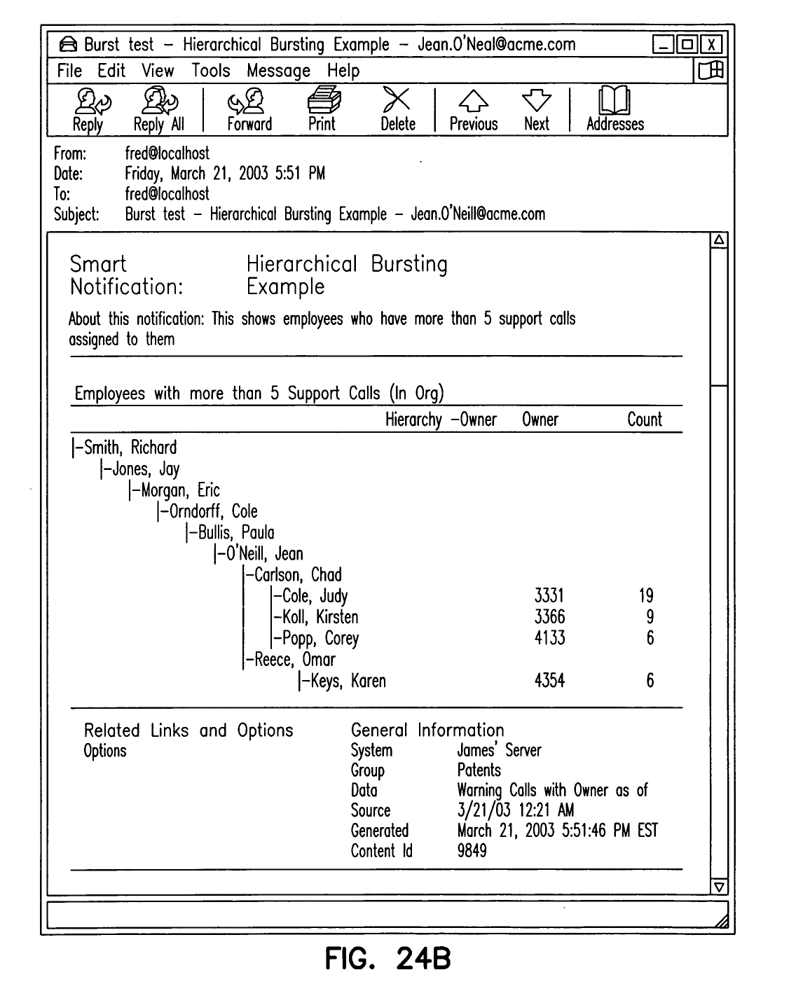

FIGS. 24a and 24b illustrate different ways to present a notification report with collaboration links 200. In the example shown in FIG. 24a, an icon 204 indicates if the user is on line by lighting up icon 204 as shown at 210. In the example shown in FIG. 24b, the name of the user is color coded to indicate if the user is on line. Clicking on the user name will bring up an IM session.

Other indicators could be used as well.

Burst Notification Based on the Hierarchical Data

In the example given above for tracking late paying customers by account representative, the resulting notification report is a notification report with a hierarchy that showed where the account representatives fit into the organization. In previous systems, such reports were delivered to each account representative. It was up to them to sift through the data to extract only those pieces pertinent to the particular account representative.

In contrast, in one embodiment, system 100 uses the hierarchy to burst tailored messages to each account representative. Bursting is where processor 102 takes one notification report and breaks it into a lot of smaller notification reports. If we take the example above, you probably have an organization that is fairly symmetrical above each account representative. Account representatives report to regional managers, who report to area executives, who report to the sales VP. When bursting is enabled, processor 102 breaks the hierarchy into views relevant to each account representative and only sends those views to each account representative.

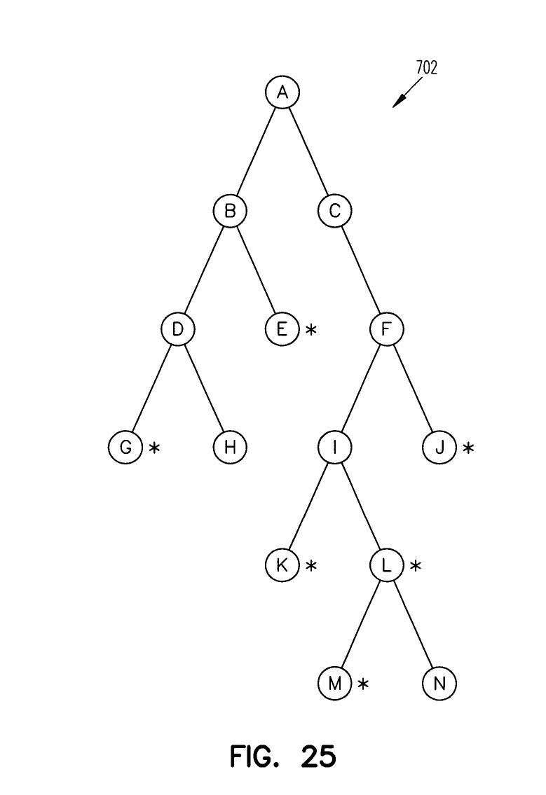

For example, the information systems department wants to periodically notify users if they have over a gigabyte of data in their mailbox. At the same time, they want to notify the person's supervisor and the supervisor's supervisor. The set of people with mailboxes greater than one gigabyte in size is distributed across the organization; they are not likely to be at one particular level. An example of this is shown in FIG. 25.

In the example shown in FIG. 25, organization hierarchy 702 shows each member of an organization and their place within the organization. As shown in FIG. 25, members B and C report to member A while members D and E report to member B, and so on.

An asterisk is shown next to each member who has over a gigabyte of data in their mailbox. As noted above, the information systems department wants to periodically notify users if they have over a gigabyte of data in their mailbox. At the same time, they want to notify the person's supervisor and the supervisor's supervisor. To accomplish this, processor 102 generates a notification report at predefined intervals containing each member with more than one gigabyte of information in their mailbox and applies the organization hierarchy to it. It then bursts a notification report to each of the individuals, to their supervisors and to their supervisor's supervisor.

In the example shown in FIG. 25, this would entail sending an email to members G. D and B regarding member G, an email to members E, B and A regarding member E, an email to members K, I, and F regarding member K, an email to members L, I and F regarding member L, an email to members M, L and I regarding member M, and an email to members J, F and C regarding member J. In one embodiment, the email to member B combines the information in the email to member G with the information in the email to member E. Similarly, the email to member I combines information in the emails to members K, M and L, and so on.

In an organization having thousands of members, the notification report is sent, therefore, only to those who can do something with the information they receive and only contains information relevant to that person.

As noted above, data within a single notification report can be read from one or more data sources. The notification report creator specifies which data column contains recipients or data from which recipients can be derived. Processor 102 filters all of the tables in the notification report for each recipient and generates a document to be delivered.

Recipients can be derived in different ways. For instance, recipients email addresses can be pulled from the data column. In another approach, email addresses can be constructed by combining the data in the column with a format, e.g. [value]@lawson.com, where [value] will be replaced with values from the data column. In another approach, if the data column contains employee ids email addresses can be pulled from a table of information about employees (this information can be read from a number of data sources). This can also be performed for customer IDs, vendor IDs or any other kind of ID that processor 102 can map to a delivery address.

Furthermore, if the data column contains employee ids and processor 102 has been provided with hierarchical information, recipients can be derived from the organization within the hierarchy. The recipient(s) can be the supervisor of the employee, the supervisor's supervisor, the person at the top of the organization, or people at specific levels within the organization (e.g., the second, third or fourth level of the organization).

Notification report recipients can be determined from the data being filtered using complex business logic. A message can be generated to hourly workers who haven't filled in their timecards. A summary message could be sent to their supervisor, and a summary of that to the supervisor's supervisor. The result is a system which efficiently handles large volumes of notification reports with very little administration.

In one embodiment, any recipient will only receive one document. Processor 102 collates any data necessary to in order to do this. As noted above, in one embodiment, each table is stored as XML. When the hierarchy is applied, each entry in the table is modified to include the member and all members above that member in the hierarchy. When the notification report is displayed the display program looks at each row and determines how to display the data in the most optimal way. For hierarchical bursting, processor 102 goes to each row and adds each member listed in the row to a list. Processor 102 then goes to the next row and adds any members it finds that are not already on the list to the list. Then, starting at the first person on the list, the table is traversed to extract data relevant to that member. An email containing that data is then sent to that member and processor 102 moves to the next person on the list.

In another embodiment, an email for each row in the table is sent to all members listed in the row.

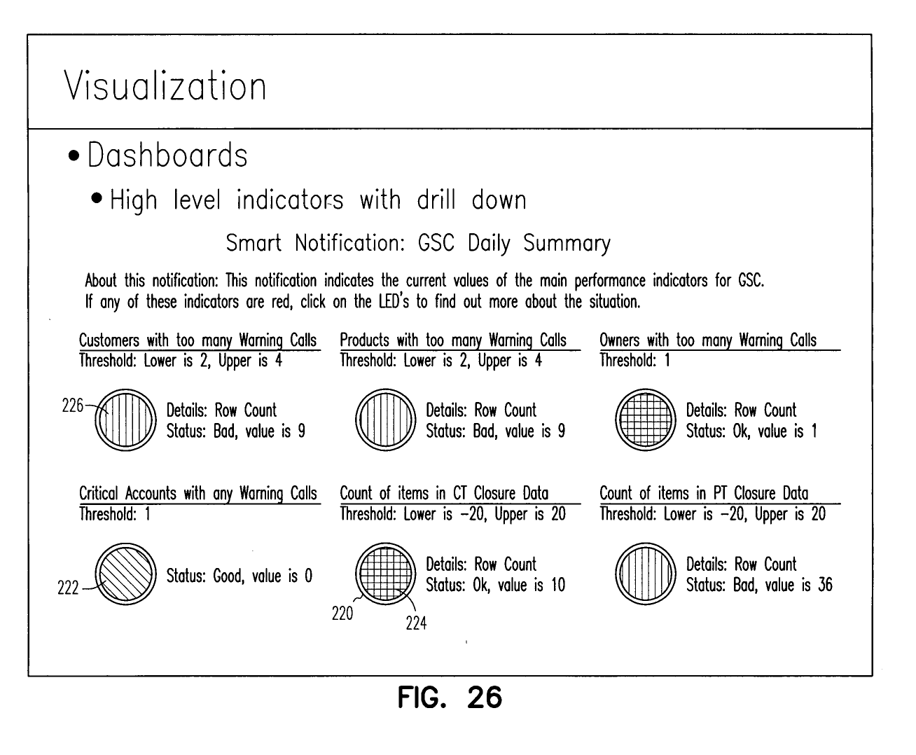

In one embodiment, notification reports from processor 102 are displayed in workstation 106 or other viewing device 108 in the form of dashboards or dials. One such embodiment is shown in FIG. 26. In the embodiment shown in FIG. 26, icons 220 are colored green 222, yellow 224 or red 226 as a function of where a value falls within a range. In the example shown, the color changes as the data reported moves across the range. Such a dashboard could be displayed in the morning when the system first connects to processor 102, or could be refreshed periodically during the day. The dashboard could also be updated when a change occurs which pushes through a threshold. For instance, processor 102 could push a notification message to workstation 106 when an indicator icon 220 would switch from green to yellow, or from yellow to red.

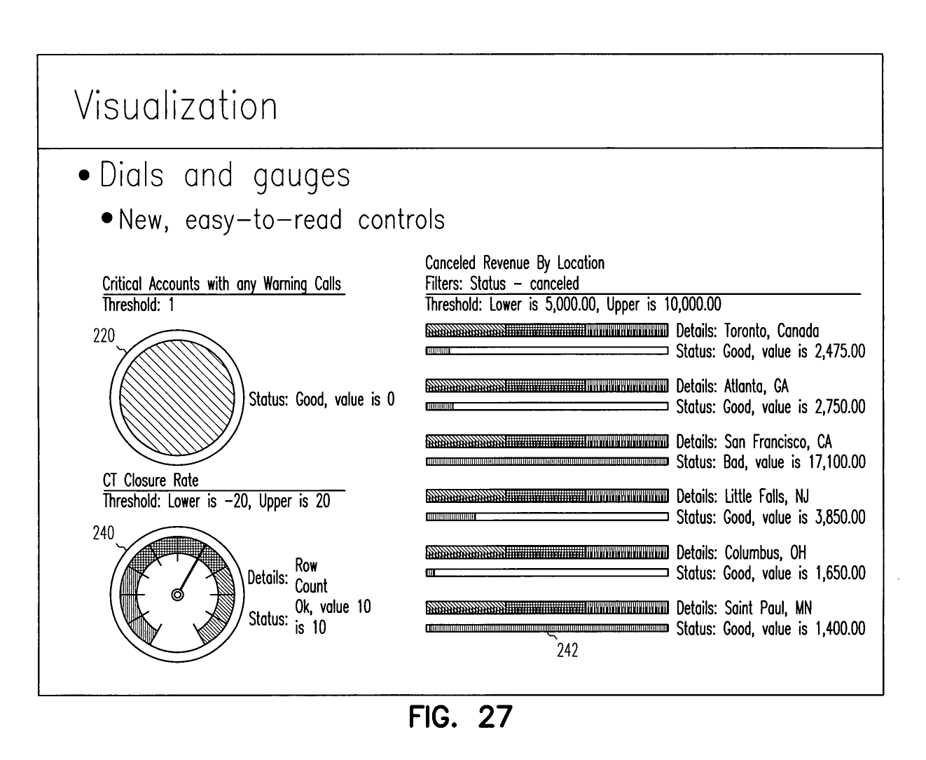

A different type of display is shown in FIG. 27. In the system of FIG. 27, dials 240 and indicator bars 242 are used to shown not only the state of the data, but also its value.

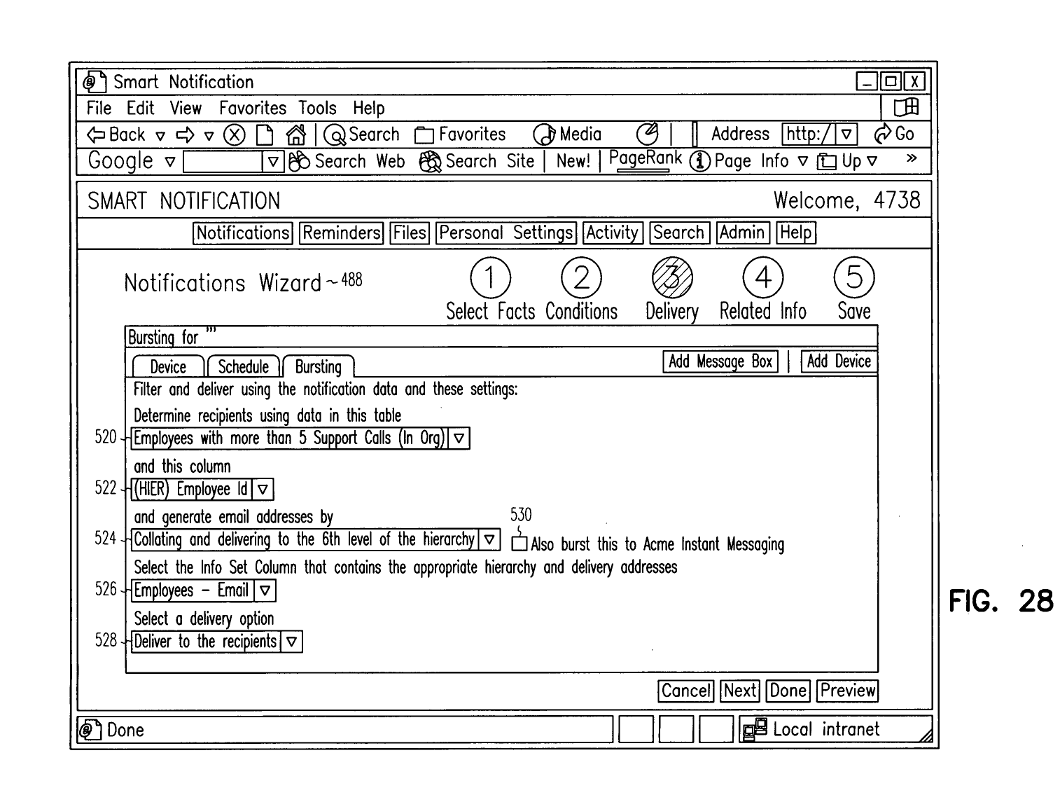

A method of configuring notification report delivery is shown in FIG. 28. In the example shown in FIG. 25, wizard 488 configures filtering and delivery of notification report data through a series of drop down menus 520 through 528. In the embodiment shown, menu 520 defines the table within the notification report 146 used to determine who will receive the notification report message. Recipients will be identified based on the column identified in menu 522, and using an option from menu 524 that specifies relationships with the values in the column or with the top of the organization.

The email address used for each recipient and any delivery options are defined in menus 526 and 528, respectively. In one embodiment, a check box 530 is also supplied to enable parallel delivery of notification reports through instant messaging as discussed above.

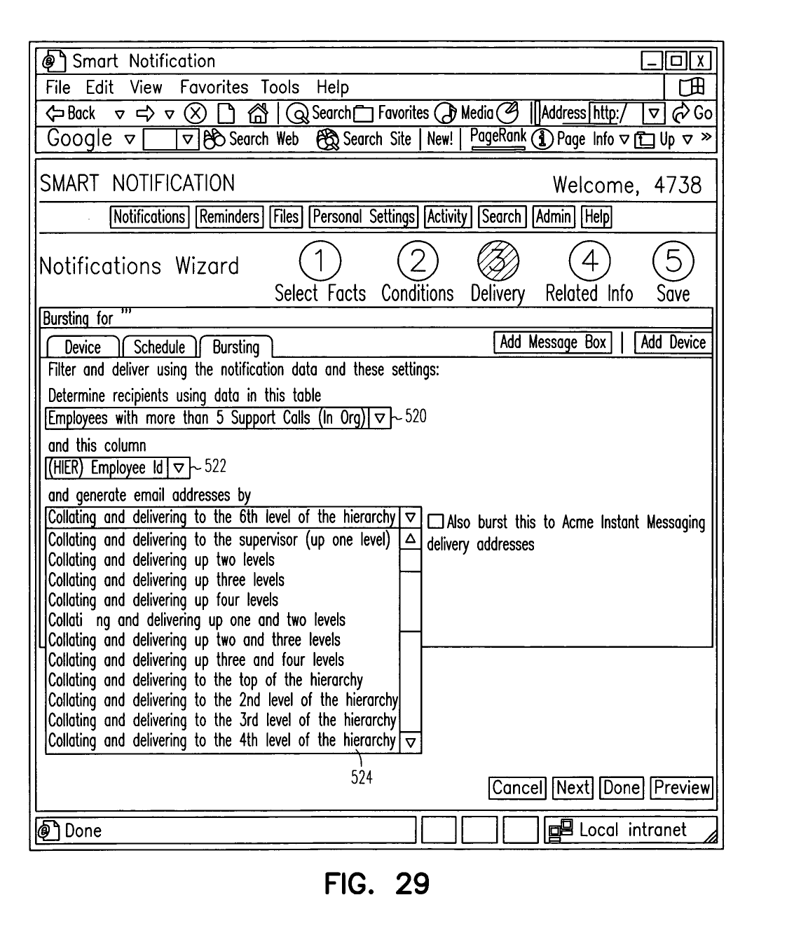

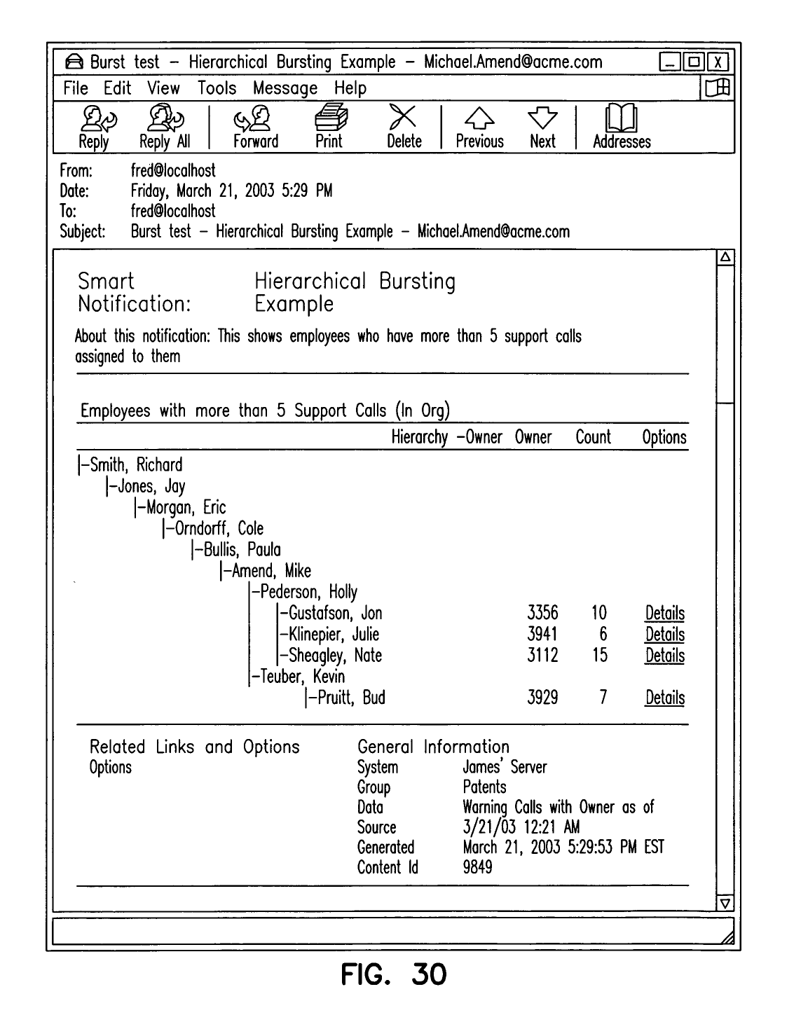

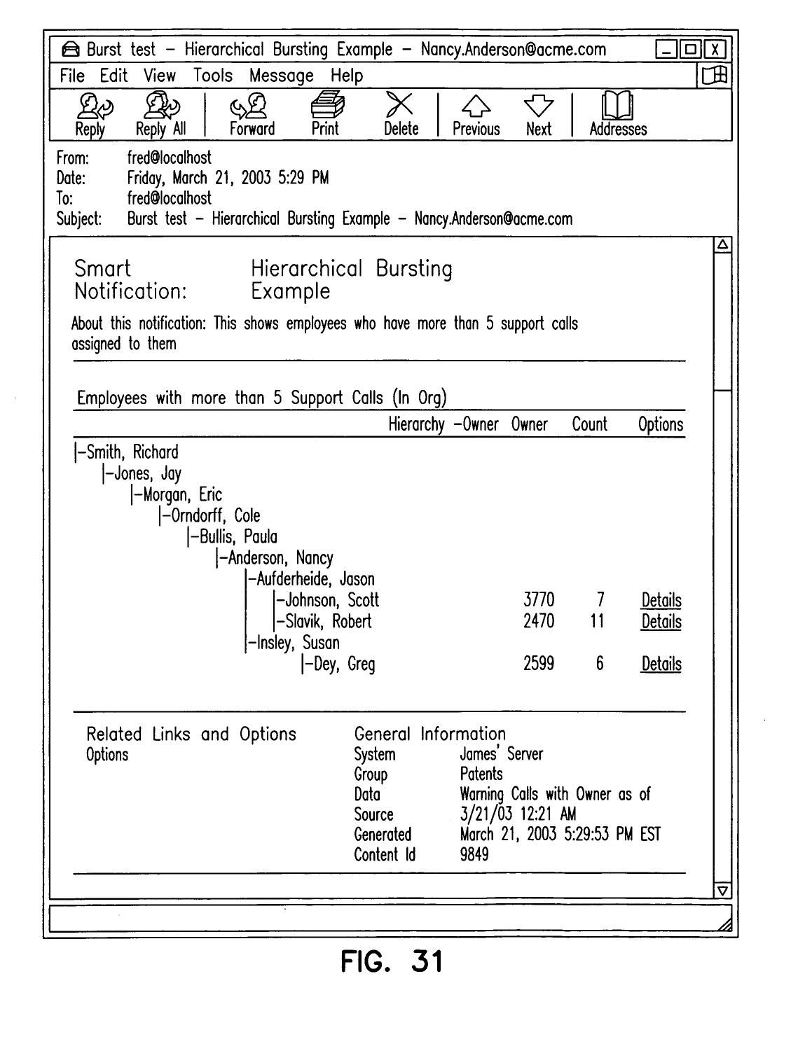

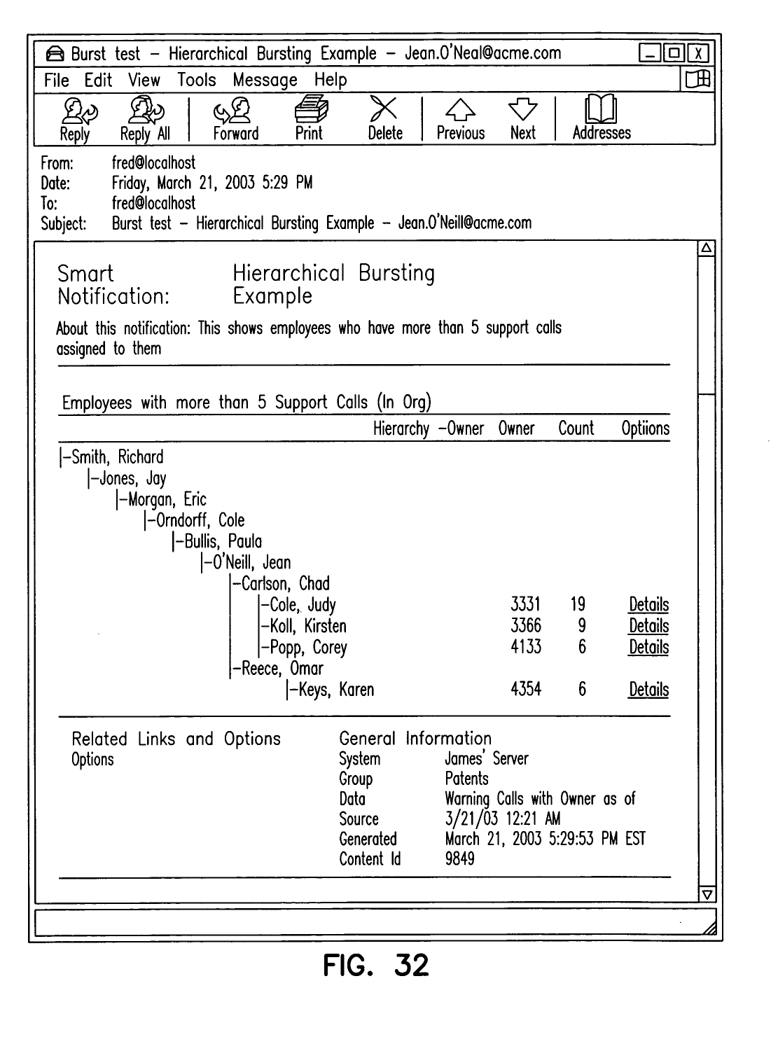

An example of the types of notification reports which can be sent to and the people who receive them is given in FIG. 29. An example of a notification report which would be sent to Mike Amend is given in FIG. 30. An example of a notification report which would be sent at the same time to Nancy Anderson is shown in FIG. 31. Finally, an example of a notification report which would be sent at the same time to Jean O'Neill is shown in FIG. 32.

In order to do the bursting, processor 102 needs an ID for a member of an organization and an email associated with that member. In one embodiment, processor 102 operates without hierarchy information to send burst notification reports to members of a group. For instance, system 100 may have an infoset 301 which has customers and the customer contact email. Processor 102 can burst notify customers to inform them of invoices that can be fulfilled because products were out of stock.

Similarly, processor 102 could burst out to vendors, telling them that there was a mismatch between their purchase order and their invoice and that the invoice would not be paid until the mismatch was resolved. In one such embodiment, system 100 has one table which lists all of the mismatched invoices and another table listing email addresses for each vendor. Processor 102 goes to the vendor table to get the mapping between the vendor ID and the email. It then filters the mismatched invoices for predefined criteria. Processor 102 then sends out unique emails to each of the vendors based on the filtered data.

Adding Custom Links to Notification Reports

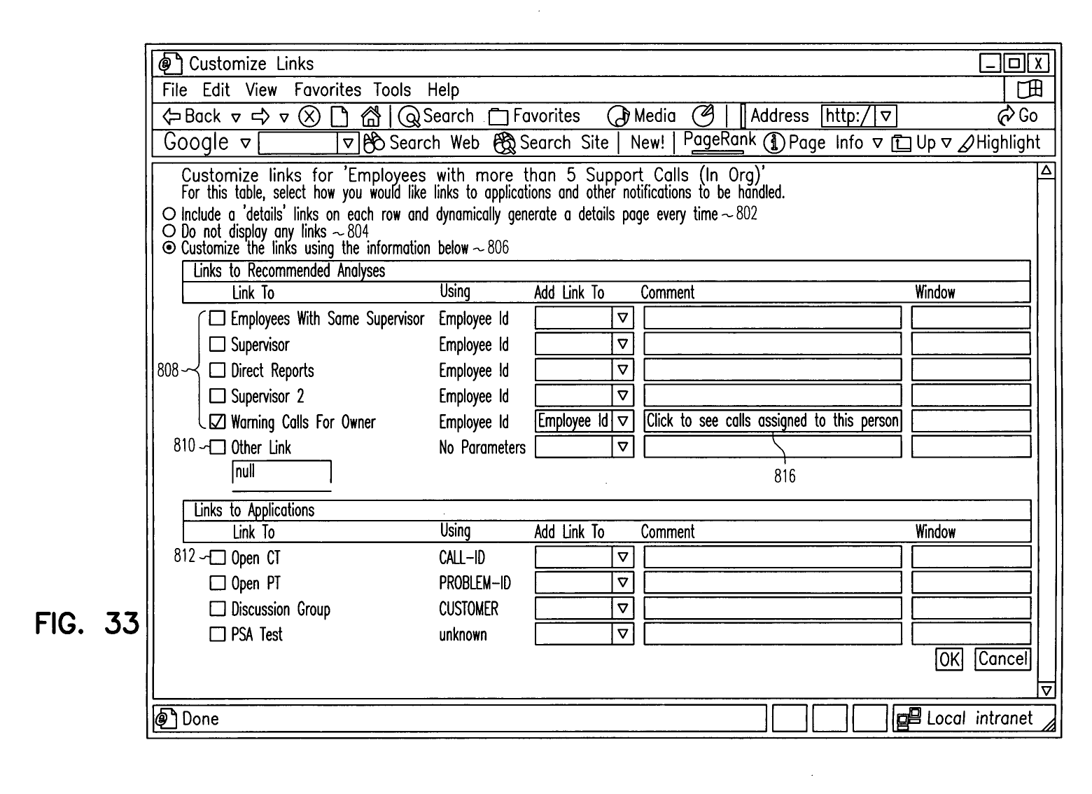

A method for adding custom links to data displayed in a notification report is shown in FIG. 33. In the example shown in FIG. 33, the notification report associated with “Employees with more than 5 Support Calls” discussed above can be configured in a number of ways to add additional information to the notification report. In the example shown, one may choose between displaying no links (804), displaying a “details” link on each row (802), or displaying a customized link (806). If the customized link is chosen, one can choose from a number of analyses 808 tied to the employee ID parameter, or can associate another link (810) with one of the displayed parameters. In the example show, a link is indicated between the employee ID and the warning calls assigned to that employee. A comment field 816 is included for clarity.

One can also include links to other applications. For instance, as is shown in FIG. 33, at 812, one can make a link between the call ID and an application named “CT”. Other links can be made as well.

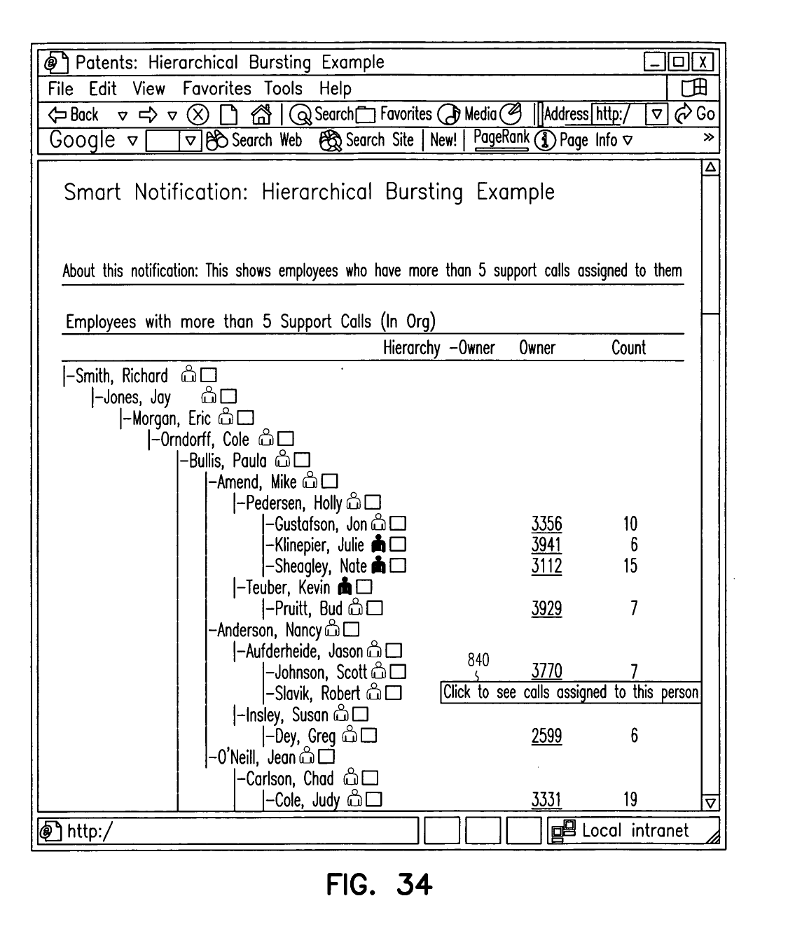

A notification report based on the configuration chosen in FIG. 33 is shown in FIG. 34. Each user ID is underlined. In this embodiment, the underlining indicates one can double click on the user ID to be taken to the linked analysis. In the embodiment shown, a fly by help display 840 displays the comment field 816 from FIG. 33.

In one embodiment, a link is provided into another notification report, which may be the derived piece. For instance, one notification report shows customers who have more than four open support calls. The list may include ten customers, with each customer underlined to show that a link exists to some other report or application. If the user clicks on the name of the customer, processor 102 displays the notification report that lists the six support calls for this customer. When the user is looking at that, he may see that the support calls are only owned by two people. If he clicks on the name of one of those people, processor 102 displays a notification report which shows all of the cases that person is working on. Now, if he wants to solve this customer's problem, he knows that there are only two people in the organization that can help him. He may find out that one of the people has 120 cases he is working on and realize the person is overloaded. Or he may click on the case number for this particular case and be taken by processor 102 into the application 104 where we got the customer call data.

In the above discussion and in the attached appendices, the term “computer” is defined to include any digital or analog data processing unit. Examples include any personal computer, workstation, set top box, mainframe, server, supercomputer, laptop or personal digital assistant capable of embodying the inventions described herein.

Examples of articles comprising computer readable media are floppy disks, hard drives, CD-ROM or DVD media or any other read-write or read-only memory device.

Portions of the above description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A computer-implemented method of determining a hierarchy of employees within an organization, comprising:
extracting organization information from a plurality of data sources; and
linking employees as a function of the organization information to form a hierarchy of employees.

2. The method according to claim 1, wherein linking includes displaying a graphical representation of the hierarchy of employees.

3. An article comprising a computer readable medium having instructions thereon, wherein the instructions, when executed in a computer, create a system for executing the method of claim 1.

4. A computer-implemented method of generating a report tailored to a user within an organization having a hierarchy, the method comprising:
providing information regarding the organization hierarchy, wherein providing information includes providing information locating the user within the organization hierarchy;
extracting data from one or more data sources; and
generating a report, wherein generating a report includes filtering the report as a function of the user's location in the organization hierarchy.

5. The method of claim 4, wherein generating further includes delivering the report via instant messaging.

6. The method of claim 5, wherein delivering the report via instant messaging includes indicating active users.

7. The method of claim 4, wherein delivering the report via instant messaging includes retrieving the user's instant messaging address.

8. The method of claim 7, wherein delivering the report via instant messaging includes indicating active users.

9. The method of claim 4, wherein generating further includes delivering the report via email.

10. The method of claim 9, wherein delivering the report via instant messaging includes retrieving the user's instant messaging address.

11. An article comprising a computer readable medium having instructions thereon, wherein the instructions, when executed in a computer, create a system for executing the method of claim 4.

12. A computer-implemented method of generating a report tailored to a user within an organization having a hierarchy, the method comprising:
extracting organization information from one or more data sources;
determining an organization hierarchy from the extracted organization information, wherein determining organization hierarchy includes locating the user within the organization hierarchy;
extracting data from one or more data sources; and
generating a report, wherein generating a report includes filtering the report as a function of the user's location in the organization hierarchy.

13. The method of claim 12, wherein generating further includes delivering the report via instant messaging.

14. The method of claim 13, wherein delivering the report via instant messaging includes indicating active users.

15. The method of claim 12, wherein delivering the report via instant messaging includes retrieving the user's instant messaging address.

16. The method of claim 15, wherein delivering the report via instant messaging includes indicating active users.

17. The method of claim 12, wherein generating further includes delivering the report via email.

18. The method of claim 17, wherein delivering the report via email retrieving the user's email address.

19. An article comprising a computer readable medium having instructions thereon, wherein the instructions, when executed in a computer, create a system for executing the method of claim 12.

20. A report generating system for use in a data system having a plurality of data sources, wherein each data source includes organization information about people within an organization, the report generating system comprising:
a processor connected to a plurality of data sources, wherein the processor extracts organization information from the plurality of data sources, determines an organization hierarchy from the extracted organization information and generates a report as a function of a user's place within the organization hierarchy; and
means for viewing the report generated by the processor.

21. A report generating system for generating reports tailored for people within an organization, the system comprising:
a report viewing system;
a plurality of data sources, wherein each data source includes organization information about people within the organization; and
a processor connected to a plurality of data sources and to the report viewing system, wherein the processor extracts organization information from the plurality of data sources, determines an organization hierarchy from the extracted organization information and generates a report as a function of a user's place within the organization hierarchy.

22. A computer-implemented method of delivering reports tailored to users within an organization having a hierarchy, the method comprising:
extracting organization information from one or more data sources;
determining an organization hierarchy from the extracted organization information, wherein determining organization hierarchy includes locating the users within the organization hierarchy;
extracting data from one or more data sources;
generating a report for each user, wherein generating a report includes filtering each user's report as a function of the user's location in the organization hierarchy; and
delivering the reports via instant messaging.

23. The method of claim 22, wherein delivering the report via instant messaging includes indicating, within one or more reports, users who are available on a network.

24. The method of claim 22, wherein delivering the report via instant messaging includes retrieving each users' instant messaging address.

25. The method of claim 22, wherein delivering the report via instant messaging includes adding links within each report to supporting data.

26. An article comprising a computer readable medium having instructions thereon, wherein the instructions, when executed in a computer, create a system for executing the method of claim 22.

27. A computer-implemented method of delivering reports tailored to users within an organization having a hierarchy, the method comprising:
extracting organization information from one or more data sources;
determining an organization hierarchy from the extracted organization information, wherein determining organization hierarchy includes locating the users within the organization hierarchy;
extracting data from one or more data sources;
generating a report for each user, wherein generating a report includes filtering each user's report as a function of the user's location in the organization hierarchy; and
delivering the report via email.

28. The method of claim 27, wherein delivering the report via email includes retrieving each users' email address.

29. The method of claim 27, wherein delivering the report via email includes adding links within each report to supporting data.

30. An article comprising a computer readable medium having instructions thereon, wherein the instructions, when executed in a computer, create a system for executing the method of claim 27.
